(19) United States
(12) Patent Application Publication
(10) Pub. No.: US 2013/0110678 A1
(43) Pub. Date: May 2, 2013

(54) PURCHASING A PRODUCT IN A STORE USING A MOBILE DEVICE

(71) Applicants: Benjamin Vigier, San Francisco, CA (US); Corey Fugman, San Jose, CA (US); Filip Krsmanovic, San Francisco, CA (US); Rudolph Van Der Merwe, Portland, OR (US); Samuel G. Noble, Portland, OR (US); Yingfeng Su, Santa Clara, CA (US); Khawaja Shams, Milpitas, CA (US); Vijay Mariadassou, Cupertino, CA (US)

(72) Inventors: Benjamin Vigier, San Francisco, CA (US); Corey Fugman, San Jose, CA (US); Filip Krsmanovic, San Francisco, CA (US); Rudolph Van Der Merwe, Portland, OR (US); Samuel G. Noble, Portland, OR (US); Yingfeng Su, Santa Clara, CA (US); Khawaja Shams, Milpitas, CA (US); Vijay Mariadassou, Cupertino, CA (US)

(73) Assignee: Apple Inc., Cupertino, CA (US)

(21) Appl. No.: 13/555,753

(22) Filed: Jul. 23, 2012

Related U.S. Application Data
(60) Provisional application No. 61/554,908, filed on Nov. 2, 2011.

(51) Int. Cl. G06Q 30/06

(52) U.S. Cl. 705/26.61

(57) ABSTRACT

Customers can use their own mobile devices to pay for products in a “self-service” transaction, without the assistance of a store employee and without the need for the store to provide a self-service checkout kiosk. The customer's device communicates with a server maintained by the store to identify the product(s) being purchased and to provide a digital credential that the server can use to look up financial account information for the customer. The server can process a payment transaction to the financial account and notify the customer's device of the result. In some cases, an employee device can provide product identification for a purchase to the server and associate the customer device with the purchase, allowing the customer to complete the transaction directly with the store server.

### CROSS-REFERENCES TO RELATED APPLICATIONS

This application claims priority under 35 USC §119(e) to U.S. Provisional Patent Application No. 61/554,908 filed on Nov. 2, 2011, the contents of which are incorporated by reference herein in its entirety for all purposes.

This application is related to U.S. patent application Ser. No. 13/476,765, filed on May 21, 2012.

### BACKGROUND

The present disclosure relates in general to systems and methods for purchasing products, and in particular to purchasing of a product in a store using a mobile device.

Retail purchase transactions in a store generally require a customer and a store employee. The customer enters the store, selects one or more products to be purchased, and brings them to a checkout stand, where the employee determines the total price (including any applicable taxes, service fees, etc.), typically using a cash register or similar system, and collects the payment from the customer. Payment can be made using various media such as cash; a check; or a purchase card such as a credit card, debit card, or prepaid card (e.g., gift card or gift certificate). A receipt, usually printed on paper, is given to the customer, who can then leave the store with the purchased product(s).

Some stores now provide self-service checkout kiosks, where a customer can determine the total price of the products and pay without direct intervention of a store employee. Given the difficulty many customers encounter in using self-service checkout kiosks, stores that offer them generally find it necessary to have an employee devoted to overseeing use of the self-service checkout kiosks.

More recently, some stores have provided employees with mobile devices capable of accepting at least some forms of payment. For example, an employee can carry a mobile purchase card reader that can read the magnetic stripes that are found on most credit or debit cards and some other types of purchase cards. Thus, rather than the customer going to a checkout stand, the employee can go to the customer. In some instances, the sales receipt can be sent to the customer electronically, e.g., via e-mail. Such systems can reduce the time customers spend waiting to pay for merchandise, as every employee can be equipped with a payment-accepting mobile device.

Even when employees are equipped with payment-accepting mobile devices, the customer still has to locate an employee in order to complete a purchase. When a store is particularly busy, this can be difficult to do. Further, the payment-accepting mobile devices are typically limited to certain forms of payment, such as credit cards, debit cards or other payment media with magnetic stripes. A customer who does not have such media generally has to go to a checkout stand to pay in cash.

### SUMMARY

Certain embodiments of the present invention relate to purchasing systems and methods that provide increased convenience. In some embodiments, customers can use their own mobile devices to pay for products in a “self-service” transaction, without the assistance of a store employee and without the need for the store to provide a self-service checkout kiosk. The customer's device communicates with a “store server” (which can be any server that is used to manage operations for a store and which may or may not be physically located within the store) to identify the product(s) being purchased and provide information usable to charge the price of the product(s) to the customer's account. In some embodiments, the information is provided in the form of a digital credential uniquely associated with the customer that can be used by the store server to look up account information for a financial account (e.g., a credit-card account, deposit account, or prepaid account) maintained by the customer, and the store server can use the financial account information to process a payment transaction with the account provider. The customer's device can communicate with the server to initiate a payment transaction and can receive confirmation when the payment transaction is complete. The customer can leave the store with the purchased product(s) and can show the confirmation to store employees if asked.

In some embodiments, a purchase can be facilitated by an employee. For example, the employee can operate a device (which can be a mobile device) that also communicates with the store server. The employee can provide product information to the server for the product(s) to be purchased and determine the total price to be paid. The employee can then instruct the server to associate the purchase transaction with the customer's mobile device, and the customer can use her mobile device to complete the purchase transaction. This aspect of the process can be similar to the self-service payment described above, with the customer's device supplying a digital credential that the store server uses to determine financial account information and process a payment transaction.

Certain aspects of the invention relate to methods for purchasing a product. A customer mobile device (which is carried and operated by a customer) can obtain a product identifier for a product offered for sale in a store and can transmit the product identifier to a store server associated with the store. The customer mobile device can receive product information from the store server, the product information including a price of the product and can presenting to the customer at least some of the received product information, including the price of the product. The customer mobile device can receive purchasing input from the customer, the purchasing input including a digital credential for the customer. The digital credential can include any information (e.g., a user identifier and a password) that is usable to access a user account record maintained for the customer at an account data server; the user account record can store financial account information for a financial account of the customer. The customer mobile device can transmit a purchase request to the store server, the purchase request including the digital credential, and the store server can use the digital credential to obtain the financial account information and use the financial account information to charge the price of the product to the financial account of the customer. The customer mobile device can receive a purchase confirmation from the store server, the purchase confirmation indicating that the product has been purchased by the customer and can present a confirmation message confirming that the purchase transaction for the product has successfully completed.

In some embodiments, a customer device can transmit purchase requests to a store server only after detecting that it has entered the store with which the store server is associated. The customer device can detect entering the store in various ways, for example by determining its own current location of the customer device and comparing its current location to a known location of the store. As another example, the customer device can establishing a connection to the store server using a local area network and, once connected, recognize the store server as being associated with the store.

The customer device can obtain product information in a number of ways. For example, a camera of the customer device can be used to capture an image of a product identification symbol (e.g., a barcode, QR code, or other symbol), and the customer device can analyze the image to determine the product identifier. In some embodiments, the customer device can capture and analyze an image to compute a candidate product identifier, then determine if the candidate product identifier is usable; if not, the customer device can provide a visual prompt to the customer indicating how to adjust the camera so as to improve the image and retry the image capture and analysis. This capture-analysis-prompt sequence can be repeated until a usable candidate product identifier is obtained. In other embodiments, the customer device can be used to capture an image of the candidate product, e.g., an image provided on the packaging material of the candidate product. The image can be used to identify the product and obtain product information associated with that product.

Certain aspects of the invention relate to methods for selling a product to a customer at a store. A store server (which can be any server associated with the store) can establish a wireless connection to a customer mobile device carried by a customer while the customer mobile device is present in the store. Via this connection, the store server can receive product identifying information for a product to be purchased by the customer, determine a price of the product, and provide product-related information (including the price) to the customer mobile device. The store server can receive a purchase request from the customer mobile device, and the purchase request can include a digital credential for the customer. The store server can communicate with an account data server (which can be remote from and unaffiliated with the store) to obtain financial account information for a financial account of the customer using the digital credential, then communicate with a payment processing server (which can also be remote from and unaffiliated with the store) to process a payment transaction using the obtained financial account information. The store server can determine whether the payment transaction was successfully processed and transmit a notification to the customer mobile device to indicate whether the payment transaction was successfully processed.

In some embodiments, the account data server can be a server that maintains user account records for some number of users (including the customer involved in the transaction). Each user account record can include financial account information. The digital credential supplied to the store server from the customer device can be used to access the particular user account record that is maintained for the customer.

In some embodiments, the user can set a user preference parameter in her user account record to indicate whether in-store self-service transactions are permitted. In such embodiments, the store server can determine whether the user account maintained for the customer permits in-store self-service transactions. If in-store self-service transactions are not permitted, the store server can send a notification to the customer device to indicate that the user account cannot be used for the transaction.

Certain other aspects of the invention also relate to methods for selling a product to a customer at a store. A store server can establish a wireless connection to a customer mobile device carried by a customer while the customer mobile device is present in the store and can receive from the customer mobile device product identifying information for a product to be purchased by the customer. The store server can determine whether a self-service transaction is permitted for the product. This determination can be based on various decision criteria such as the price of the product, the location of the store, and/or the type of product being purchased. The store server can provide product-related information including the price of the product and an indication of whether the self-service transaction is permitted for the product. If a self-service transaction is permitted, the store server can process the transaction, e.g., in a manner similar to that described above.

Certain aspects of the invention relate to methods for selling a product to a customer in a store in an employee-assisted transaction. A store server associated with the store can receive a payment request message from a customer device (e.g., a mobile device) operated by a customer in the store. The payment request message can include a customer identifier and an indication that the customer will purchase a product using the customer device. The store server can also receive a transaction creation message from an employee device (e.g., a mobile device) operated by an employee in the store. The transaction creation message including a customer identifier of a customer making a purchase of a product. Based on matching customer identifiers between the payment request message and the transaction creation message, the store server can associate the messages and thereby recognize that a particular employee device is facilitating a sale involving a particular customer device. The store server can then send a transaction detail message to the customer device. The transaction detail message including a price for the transaction and product identifying information for one or more products to be purchased by the customer. (In some embodiments, the product identifying information is provided by the employee device, either together with or separately from the transaction creation message.) The store server can receive a payment instruction message from the customer device. The payment instruction message can include a digital credential associated with the customer. The store server can process the purchase transaction using the digital credential; processing the purchase transaction can include charging the price of the product to a financial account associated with the digital credential. In response to successful processing of the purchase transaction, the store server can send confirmation messages to both employee device and the customer device.

In some embodiments, the store server maintains a queue of customer identifiers of all customers waiting to pay and provides the current content of the queue to employee devices upon request. In response to receiving the payment request message from the customer device, the store server can add the customer identifier to the queue. When the employee device so requests, the server can send the current content of the queue, and the employee operating the employee device can select a particular customer from the queue; the selected customer identifier can be included in the transaction creation message. After processing the purchase transaction, the store server can remove the customer identifier from the queue. During processing of the purchase transaction, the store server can mark the customer identifier to indicate that the customer is currently being helped.

The store server can process the purchase transaction for an employee-assisted purchase similarly to a self-service purchase transaction. For example, the store server can communicate with an account data server remote from the store to obtain financial account information for a financial account of the customer using the digital credential, then communicate with a payment processing server remote from the store to process a payment transaction using the obtained financial account information.

Certain other aspects of the invention relate to methods for selling a product to a customer in a store using an employee mobile device operated by an employee in the store. The employee mobile device can obtain product information for a product to be sold to a customer and provide the product information to a store server associated with the store. The employee mobile device can receive price information (e.g., total price including taxes, discounts, etc.) from the store server. The employee mobile device can indicate to the store server that the customer will pay for the product using a digital credential and can receive from the store server a list of customers waiting to pay. The employee mobile device can send to the store server an identification of one of the customers on the list as the customer who will pay for the product. In response to this identification, the store server can perform a purchase transaction with a customer mobile device carried by the customer (without further participation by the employee mobile device). When the purchase transaction is complete, the employee mobile device can receive a confirmation from the store server.

The following detailed description together with the accompanying drawings will provide a better understanding of the nature and advantages of the present invention.

### BRIEF DESCRIPTION OF THE DRAWINGS

FIG. 1 illustrates a shopping system according to an embodiment of the present invention.

FIG. 2 is a simplified block diagram of an implementation of a customer device according to an embodiment of the present invention.

FIG. 3 is a simplified block diagram of an implementation of an employee device according to an embodiment of the present invention.

FIG. 4 is a simplified block diagram of an implementation of a store server according to an embodiment of the present invention.

FIG. 5 is a flow diagram of a process for using a customer device to purchase a product in a self-service transaction according to an embodiment of the present invention.

FIG. 6 is a flow diagram of a process for facilitating a self-service transaction according to an embodiment of the present invention.

FIG. 7 is a flow diagram of another process for facilitating a self-service transaction according to an embodiment of the present invention.

FIG. 8 is a message passing diagram further illustrating interaction between participating entities in a self-service purchase transaction according to an embodiment of the present invention.

FIGS. 9A-9F illustrate a sequence of screen images for a customer device corresponding to different stages in a self-service transaction according to an embodiment of the present invention.

FIG. 10 is a flow diagram of a process for performing an employee-assisted purchase transaction according to an embodiment of the present invention.

FIG. 11 is a flow diagram of a process for performing an employee-assisted transaction according to an embodiment of the present invention.

FIG. 12 is a flow diagram of a process for processing an employee-assisted purchase transaction by a store server according to an embodiment of the present invention.

FIG. 13 is a message passing diagram further illustrating interaction between participating entities in an employee assisted purchase transaction according to an embodiment of the present invention.

FIGS. 14A-14G illustrate a sequence of screen images for a customer device and an employee device corresponding to different stages in an employee-assisted transaction according to an embodiment of the present invention.

### DETAILED DESCRIPTION

Certain embodiments of the present invention relate to purchasing systems and methods that provide increased convenience. In some embodiments, customers can use their own mobile devices to pay for products in a “self-service” transaction, without the assistance of a store employee and without the need for the store to provide a self-service checkout kiosk. The customer's device communicates with a server maintained by the store to identify the product(s) being purchased and provide information usable to charge the price of the product(s) to the customer's account. In some embodiments, the information is provided in the form of a digital credential uniquely associated with the customer that can be used by the store server to look up account information for a financial account (e.g., a credit-card account, deposit account, or prepaid account) maintained by the customer, and the store server can use the financial account information to process a payment transaction with the account provider. The customer's device can communicate with the server to initiate a payment transaction and can receive confirmation when the payment transaction is complete. The customer can leave the store with the purchased product(s) and can show the confirmation to store employees if asked.

In some embodiments, a purchase can be facilitated by an employee. For example, the employee can operate a device (which can be a mobile device) that also communicates with the store server. The employee can provide product information to the server for the product(s) to be purchased and determine the total price to be paid. The employee can then instruct the server to associate the purchase transaction with the customer's mobile device, and the customer can use her mobile device to complete the purchase transaction. This aspect of the process can be similar to the self-service payment described above, with the customer's device supplying a digital credential that the store server uses to determine financial account information and process a payment transaction.

The term “store” is used herein to refer to any physical location where a merchant (anyone who operates a store) offers products for sale to persons who are physically present at that location. The products can include tangible goods of any kind (such as electronic devices, computer-readable storage media containing digital data such as software or media content, sports equipment, books, clothing, food and beverage items, luggage, tools, appliances, furniture, housewares, and so on) and/or services (including services such as hair cutting or manicures, medical or dental services, tutoring services or group classes, fitness-related services such as personal training, and services associated with purchase of tangible goods such as delivery, installation, extended warranties, customer support programs, and so on). The term “employee” is used herein to refer to anyone who works in a store, regardless of actual job title or legal employment status, and the term “customer” to anyone who, while physically present in a store, purchases or attempts to purchase anything offered for sale in the store.

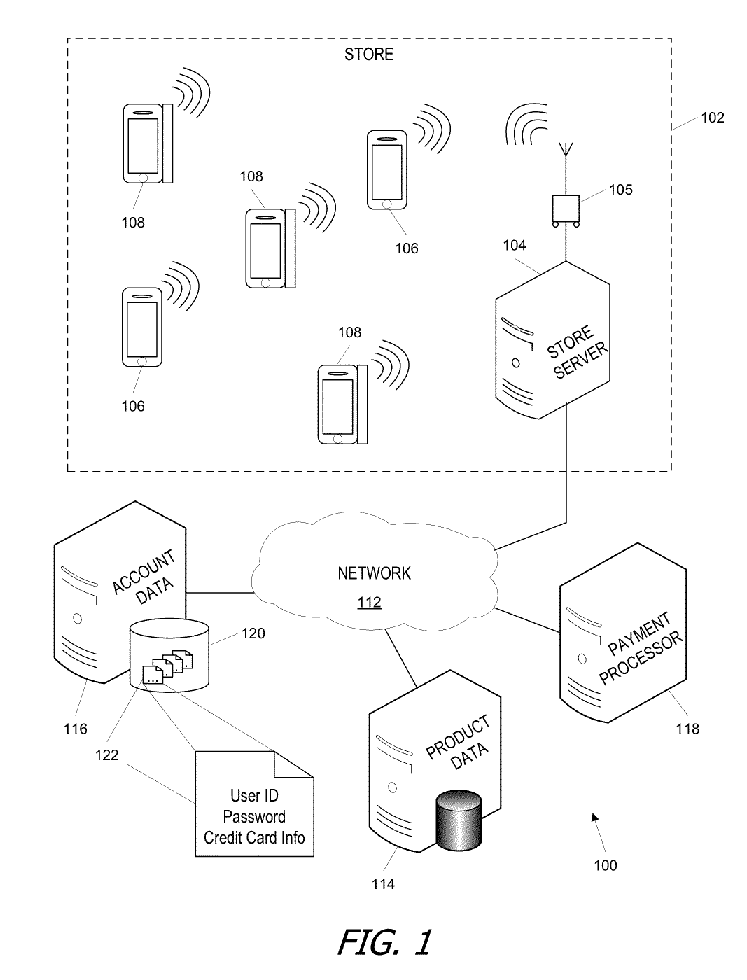

FIG. 1 illustrates a shopping system 100 according to an embodiment of the present invention. A store 102 can be any physical location where products are offered for sale. (As noted above, the products can include tangible goods and/or services of any kind.) A store server 104 is provided for management of the store. Store server 104 can include conventional server components and can be used to maintain information about product inventory levels, order products, determine and adjust prices, and complete purchase transactions, among other uses. Store server 104 can also connect to (or incorporate) a wireless access point 105 that provides wireless communication with other devices within store 102.

Customers in store 102 can carry devices 106, which can be mobile devices such as mobile phones, smart phones, personal digital assistants, tablet computers, laptop computers, or any other portable electronic device capable of operating to complete a purchase transaction; examples are described below. In some embodiments, devices 106 are owned by the customers, who can freely carry them into and out of store 102. Customer devices 106 can be capable of communicating wirelessly with store server 104, e.g., via wireless access point 105. For example, in some embodiments, a customer device 106 can be capable of detecting when it enters store 102 and can automatically establish a wireless connection to access point 105 upon entering store 102. The wireless connection can be a secure communication channel, so that other devices cannot readily intercept and interpret communications between customer device 106 and store server 104; such channels can be can established, e.g., using conventional technologies such as Wi-Fi or Bluetooth or the like.

Employees in store 102 can carry devices 108, which can be, e.g., mobile devices such as mobile phones, smart phones, personal digital assistants, tablet computers, laptop computers, or any other portable electronic device capable of operating to facilitate a purchase transaction; examples are described below. In some embodiments, employee devices 108 can be equipped with purchase card readers 110 that allow employees to complete purchase transactions made with purchase cards. (It is to be understood that other purchase media can also be supported, e.g., cards or other devices equipped with near-field communication, by providing appropriate readers.)

Employee devices 108 can also communicate wirelessly with store server 104, e.g., via wireless access point 105. Like customer devices 106, an employee device 108 can establish a secure connection to access point 105, e.g., using conventional technologies such as Wi-Fi or Bluetooth or the like. In embodiments described herein, it is not necessary for any employee device 108 to establish a direct communication channel with any customer device 106; both devices can communicate with store server 104 in a coordinated fashion to complete a transaction as described below. Alternatively, in some embodiments, a customer device 106 can communicate with store server 104 to complete a transaction without any participation by employee device 108.

In some embodiments, store server 104 can communicate via a wide area network 112 (e.g., the Internet) with various other servers. As shown, other servers can include a product data server 114, an account data server 116, and a payment processing server 118.

Product data server 114, which can be managed by an owner of store 102 (or a chain of stores that includes store 102) can provide data regarding products being sold in store 102. This data can include product information, including information about product features, options and accessories associated with the product, and product price. In some embodiments, data from product data server 114 can be retrieved in real-time (or at regular intervals) by store server 104; retrieved data can be provided to employee devices 108 and/or customer devices 106, e.g., in response to requests received from mobile devices 108 and/or 106.

Account data server 116 can maintain a data store 120 of user account records 122 associated with various user accounts, some of which may be accounts created by or for customers in store 102. For example, account data server 116 may be associated with an Internet-based purchasing system maintained by the owner of store 102 or otherwise affiliated with store 102. User account record 122 for a particular account holder can include, e.g., a user identifier, a password, and financial account information, such as a credit card number and expiration date or a bank account number, that enables purchases to be debited (or charged) against a financial account of the user. Any type of financial account can be used, including credit card accounts, prepaid or debit accounts, deposit accounts, or the like. In some embodiments, account data server 116 stores user account records 122 in a secure format to prevent unauthorized access, and store server 104 is provided with authorization instructions that allow server 104 to access user account records 122.

It is contemplated that store 102 and account data server 116 can be under common ownership or control. However, this is not required, as long as an agreement is in place between the respective owners (or other controllers) that allows store server 104 access to information from account records 122 maintained at account data sever 116.

Payment processing server 118 can be owned and operated by a financial services institution such as a bank, credit card association, third-party provider of transaction processing services, or the like. Payment processing server 118 can receive a transaction request that includes a total price to be paid and information identifying the merchant (e.g., store 102) and a customer financial account against which the price is to be charged or otherwise debited. Payment processing server 118 can complete the transaction based on the request. Transaction completion can include conventional payment-processing activities such as verifying the existence and good standing of the customer financial account; sending instructions to debit the customer financial account to the financial institution at which the customer account is maintained; and sending instructions to credit a merchant account associated with the merchant to a financial institution at which the merchant maintains a merchant account. Other payment mechanisms can also be used.

The various servers (e.g., store server 104, product data server 114, account data server 116, and payment processing server 118) shown in FIG. 1 can be implemented using conventional or other computer technologies; they can include processors, memory, storage systems on any size or scale desired, and network communication interfaces conforming to any protocol that allows the servers to communicate with each other. The servers may communicate using any combination of networking technologies and protocols, including the Internet, virtual private networks, dedicated communication paths, or the like. In some instances, a server can be implemented as a server farm incorporating multiple cooperating computer systems that may be housed at a single location or at multiple geographically dispersed locations. Any computer system capable of performing operations as described herein can be used as a server.

Store server 104 can be any server or server system capable of managing operations for a store (including purchase transactions involving a customer device as described herein). Although FIG. 1 illustrates a case where store server 104 is physically located inside store 102, it is to be understood that this is not required. In some embodiments, store server 104 can be physically remote from store 102 and can be connected to wireless access point 105, e.g., via a virtual private network implemented using Internet 112, via a dedicated private network, or the like. In some embodiments, one store server 104 can manage operations for multiple stores, and the store server can be physically located in any one of the stores (or in a different location that is not a store, such as a corporate headquarters). In some embodiments, store server 104 can be implemented in an architecture that includes multiple cooperating servers, each managing different aspects of store operations; for example, there can be different servers for inventory management, for accounting, for tax computation and compliance, for interacting with payment processors, etc., and these servers can interact to perform various operations associated with store server 104.

In operation, a customer can use system 100 to complete a purchase. More specifically, a customer device 106 in store 102 can provide to store server 104 a digital credential (e.g., a user identifier (ID) and password) associated with the customer's user account at account data server 116. Store server 104 can communicate with account data server 116 to retrieve financial account information associated with that user account, using the customer's digital credential. Store server 104 can then communicate with payment processing server 118 to complete a purchase transaction using the financial account information, after which store server 104 can communicate confirmation of the purchase to customer device 106. The customer need not present a purchase card or any other payment media; instead she can simply enter her digital credential on her own device.

It should be noted that, the manner in which store server obtains the customer's financial account information can be invisible to payment processing server 118. In particular, payment processing server 118 need not be able to distinguish a transaction in which server 104 obtains the financial account information from account data server 116 from a transaction in which store server 104 obtains the financial account information by having the customer present a card to a card reader (or by any other procedure). Thus, conventional payment processing servers can be used in connection with embodiments of the present invention.

It will be appreciated that the purchasing system of FIG. 1 is illustrative and that variations and modifications are possible. The store server can be but need not be physically present in the store; the store can have an in-store wireless network that connects (e.g., via the Internet, a private network, a virtual private network or any other type of network) to an off-site server capable of managing activity for one or more stores. Any number of employee devices and/or customer devices can be present in a store at a given time. It is not required that all customers or all employees carry mobile devices. In some embodiments, customers without mobile devices can approach an employee and pay for purchases via the employee's mobile device or a conventional checkout stand. In some embodiments, customers can perform self-service checkout transactions (examples are described below) without any participation by an employee or employee device; in such embodiments, employee devices are not required. In other embodiments, employee devices (which can be mobile devices carried by the employees or fixed devices installed in the store) can be used to facilitate purchases; examples are described below.

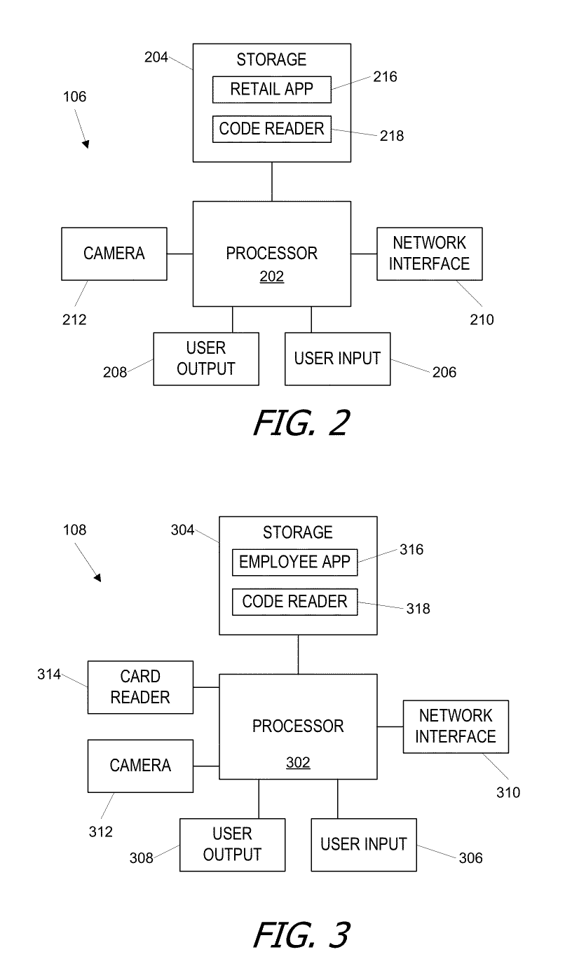

FIG. 2 is a simplified block diagram of an implementation of customer device 106 according to an embodiment of the present invention. Customer device 106 includes a processor 202, a storage subsystem 204, a user input device 206, a user output device 208, a network interface 210, and a camera 212.

Processor 202, which can be implemented as one or more integrated circuits (e.g., a conventional microprocessor or microcontroller), can control the operation of customer device 106. In various embodiments, processor 202 can execute a variety of programs in response to program code and can maintain multiple concurrently executing programs or processes. At any given time, some or all of the program code to be executed can be resident in processor 202 and/or in storage subsystem 204.

Through suitable programming, processor 202 can provide various functionality for customer device 106. For example, processor 202 can execute a retail application program (or “app”) 216 and a code reader app 218. In some embodiments, code reader app 218 may be part of retail app 216. Retail app 216 can provide various functionality such as identifying a location of a retail store (e.g., store 102 of FIG. 1) and providing information about the store, including information about specific products sold at the store. In some embodiments, retail app 216 can include functions that are enabled only when customer device 106 is within store 102. For example a user may be able to use retail app 216 to request employee assistance only while in the store. In some embodiments, retail app 216 can include features related to self-service or employee-assisted purchasing as described below, and retail app 216 can be programmed to activate these purchasing features only while customer device 106 is in the store. (As described below, in some embodiments, retail app 216 can be automatically launched when customer device 106 detects that it has entered the store.)

Storage subsystem 204 can be implemented, e.g., using disk, flash memory, or any other storage media in any combination, and can include volatile and/or non-volatile storage as desired. In some embodiments, storage subsystem 204 can store one or more application programs to be executed by processor 202 (e.g., retail app 216 and code reader app 218.). In some embodiments, storage subsystem 204 can store other data, such as media assets that can be played by customer device 106 and/or personal information (contacts, calendar data). Programs and/or data can be stored in non-volatile storage and copied in whole or in part to volatile working memory during program execution.

A user interface can be provided by one or more user input devices 206 and one or more user output devices 208. User input devices 206 can include a touch pad, touch screen, scroll wheel, click wheel, dial, button, switch, keypad, microphone, or the like. User output devices 208 can include a video screen, indicator lights, speakers, headphone jacks, or the like, together with supporting electronics (e.g., digital-to-analog or analog-to-digital converters, signal processors, or the like). A customer can operate input devices 206 to invoke the functionality of customer device 106 and can view and/or hear output from customer device 106 via output devices 208.

Network interface 210 can provide voice and/or data communication capability for customer device 106. In some embodiments network interface 210 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 210 can provide wired network connectivity (e.g., Ethernet) in addition to or instead of a wireless interface. Network interface 210 can be implemented using a combination of hardware (e.g., antennas, modulators/demodulators, encoders/decoders, and other analog and/or digital signal processing circuits) and software components.

Camera 212 can allow customer device 106 to capture and record images from the surrounding environment. Camera 212 can be of conventional design, including optical components (lenses, filters, etc.), a photo sensor (e.g., a CMOS sensor with millions of independent pixels), and associated electronics for converting signals generated by the sensor to digital image data. In some embodiments, code reader app 218 can include program instructions to assist a user in operating camera 212 to scan (i.e., capture and analyze an image of) a product identification code (e.g., a barcode or quick response (QR) code) to determine a product identifier. The product identifier can be communicated to store server 104 (e.g., via network interface 210) and can be used to retrieve product information and/or to purchase a product. In some embodiments, camera 212 can be used to capture an image of the product itself. The image can then be communicated to store server 104, which in turn can identify the product in the image. Once identified, store server can retrieve product information or assist with the purchase of the product. Examples are described below.

FIG. 3 is a simplified block diagram of an implementation of employee device 108 according to an embodiment of the present invention. Employee device 108 includes a processor 302, storage subsystem 304, a user input device 306, a user output device 308, a network interface 310, a camera 312, and a card reader 314. With the exception of card reader 314, these components can be similar or identical to corresponding components of consumer customer device 106 described above.

Card reader 314 can include a magnetic reader, near-field communications transceiver, or other suitable hardware for reading data from purchase cards or other payment media. An employee can give a customer the option to pay for a purchase by presenting a purchase card to the employee; transactions of this kind can be generally conventional in nature. In some embodiments, card reader 314 can be an external accessory that is removably attachable to employee device 108, e.g., using a suitable connection port such as a USB port, audio port, or device-specific connector port.

In some embodiments, storage subsystem 304 of employee device 108 stores application programs specific to store employee use, such as employee app 316, which can be executed by processor 302. Storage subsystem 304 can also store a code reader app 318, which can be similar or identical to code reader app 218 described above.

Employee app 316, executed by processor 302, can provide various functionality such as providing product information to the employee; identifying customers in the store who are requesting employee assistance (e.g., by using retail app 216); and processing payment transactions, e.g., using purchase cards read by card reader 314. In some embodiments, employee app 316 supports assisted purchasing using a customer device; examples of such assisted purchasing are described below. In some embodiments, employee device 108 is a mobile device (e.g., a smart phone owned by the employee), and employee app 316 can be configured to execute only while employee device 108 is in the store where the employee works (e.g., while device 108 is connected to store server 104 of FIG. 1 via wireless access point 105).

It will be appreciated that the customer and employee devices described herein are illustrative and that variations and modifications are possible. A customer device and/or employee device can be implemented as a mobile device and may have other capabilities not specifically described herein (e.g., mobile phone, global positioning system (GPS), power management, accessory connectivity, etc.). In a system with multiple customer devices and/or multiple employee devices, different devices may have different sets of capabilities; the various mobile devices can be but need not be similar or identical to each other.

Further, while the customer and employee devices are described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

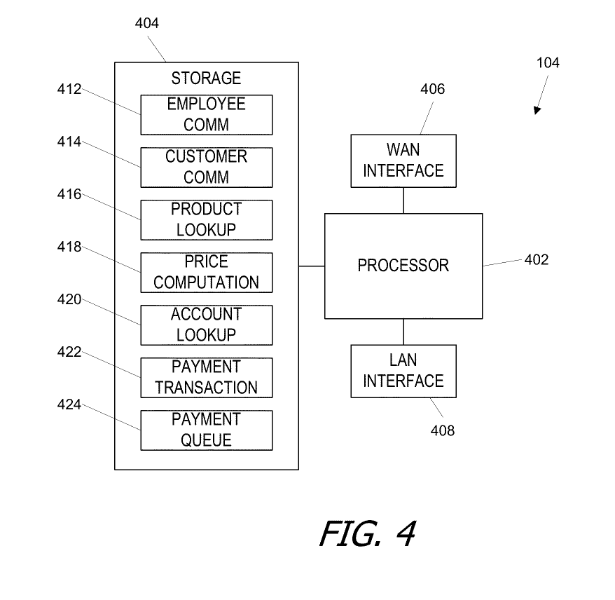

Customer device 106 and employee device 108 can communicate with a store server to perform purchase transactions and other operations. FIG. 4 is a simplified block diagram of an implementation of server 104 according to an embodiment of the present invention. Server 104 can include a processor 402, a storage subsystem 404, a local area network (LAN) interface 406, and a wide area network (WAN) interface 408.

Processor 402 can be implemented using one or more integrated circuits and can incorporate any combination of programmable and/or fixed-function components; conventional microprocessor technologies can be used. In various embodiments, processor 402 can execute programs in response to program code and can maintain multiple concurrently executing programs or processes. At any given time, some or all of the program code to be executed can be resident in processor 402 and/or in storage subsystem 404.

Through suitable programming, processor 402 can provide various functionality for server 104, including any computer-implemented operations related to supporting a retail environment. Examples include tracking inventory, storing product and price information (or accessing remotely stored information), managing employee data, scheduling of employee work hours and/or customer appointments, processing purchase transactions, and so on. Examples of particular functionality that can be implemented in server 104 in connection with embodiments of the present invention are described below.

Storage subsystem 404 can include any combination of storage media including magnetic media, optical media, semiconductor memory or storage media (e.g., DRAM, SRAM, flash memory, etc.), and so on. In some embodiments, storage subsystem 404 can store (preferably in non-volatile media) programs to be executed by processor 402, as well as store-related data.

LAN interface 406 can provide connectivity between server 104 and other nearby devices, e.g., within or near the physical environment of store 102 in FIG. 1. For example, LAN interface 406 can incorporate or connect to a wireless access point (e.g., implementing Wi-Fi or the like) for a network provided by store 102; if the wireless access point is external, the connection to server 104 can be wired or wireless as desired. (In some embodiments, LAN interface 406 implements wireless access point 105 of FIG. 1.) LAN interface 406 can support creation of communication channels between server 104 and various devices that may be present in store 102, such as consumer devices 106 and/or employee devices 108 shown in FIG. 1. In some embodiments, a separate, secure channel is established between server 104 and each device.

WAN interface 408 can provide connectivity between server 104 and a larger network, such as the Internet. WAN interface 408 can incorporate wired and/or wireless communication technologies and protocols as desired. In some embodiments, server 104 can act as a gateway allowing other devices connected to the in-store LAN to access the WAN. Any combination of networking technologies and protocols can be used, including the Internet protocol suite, virtual private networks, dedicated communication paths, or the like.

In some embodiments, the programs executed by server 104 include programs related to processing of purchase transactions using a customer device. These transactions can be self-service or employee-assisted, as described below. For example, server 104 can execute an employee communication program 412, a customer communication program 414, a product lookup program 416, a price computation program 418, an account lookup program 420, and a payment transaction program 422. These programs can be implemented as separate, cooperative programs or as code modules (e.g., subroutines) incorporated into a larger program as desired.

Employee communication program 412 can support communications between server 104 and an employee device (e.g., employee device 108 in FIG. 1). Executing program 412, server 104 can establish a separate secure communication channel (e.g., via LAN interface 408) with each active employee device within a store and can receive and respond to requests from the employee devices, including requests related to purchase transactions as described below. Server 104 can also send notifications and alerts to the employee devices in broadcast (all devices), unicast (addressed to a specific device), or multicast (addressed to selected devices) modes, e.g., to alert employees if a customer has requested assistance or if there is some other condition of which employees should be aware.

Customer communication program 414 can support communications between server 104 and a customer device (e.g., customer device 106 in FIG. 1). Executing program 414, server 104 can establish a separate secure communication channel (e.g., via LAN interface 408) with each active customer device within a store and can receive and respond to requests from the customer devices, including requests related to purchase transactions as described below. Server 104 can also send notifications and alerts to customer devices in broadcast (all devices), unicast (addressed to a specific device), or multicast (addressed to selected devices) modes, e.g., to alert a customer to upcoming events or availability of an employee to assist the customer.

Product lookup program 416 can enable server 104 to access a product information database to obtain product information using a product identifier that can be received, e.g., from a customer device or an employee device. In some embodiments, the product information database can be maintained locally to server 104; in other embodiments, the product information database can be maintained on a remote server (e.g., product data server 114 of FIG. 1), and executing product lookup program 416 can include accessing the remote server to obtain product information.

Price computation program 418 can enable server 104 determine the price to be charged for a product. In some embodiments, price computation program 418 can operate on list price information obtained using product lookup program 416 and can include computation of applicable discounts, sales taxes and any other adjustments that the owner of store 102 may choose (or be obligated by law) to apply to the list price. In some embodiments, the tax computation is specific to the location of the store where the purchase is occurring and can include all national, state, and/or local taxes that may be applicable to transactions in that store. Additional fees (e.g., recycling fees for purchases of electronic equipment), discounts, or other adjustments can be also be determined and applied based on the physical location of the store where the purchase is occurring. A store-specific calculation can be done regardless of where store server 104 is physically located, provided that price computation program 418 is informed of the location of the store where the purchase is occurring and has been provided with applicable tax rates and other location-specific data.

Account lookup program 420 can enable server 104 to access a user account record associated with a particular customer. The user account records can be maintained locally to server 104 or on a remote server (e.g., account data server 116 of FIG. 1). In some embodiments, examples of which are described below, account lookup program 420 can be executed in response to a request from a customer device that includes a digital credential specific to a user account maintained for the customer at account data server 116. Server 104 can access account data server 116 and provide the digital credential in order to retrieve information about the user account. The information can include information about a financial account that is distinct from but associated with the customer's user account and that can be used by the customer to pay for purchases. (For example, the financial account can be a deposit account or credit-card account maintained at a financial institution that is not affiliated with a provider of account data server 116.)

Payment transaction program 422 can enable server 104 to interact with a third-party payment processor (e.g., payment processing server 118 of FIG. 1) to process payment transactions using financial account information supplied by server 104. In some embodiments, server 104 can obtain the financial account information using account lookup program 420 and a digital credential supplied by a customer. Payment transaction program 422 can implement a conventional purchase-card transaction operation, including applicable security measures, and can implement charges and/or credits (e.g., refunds) to customer financial accounts.

Payment queue program 424 can enable server 104 to facilitate customer purchases in an employee-assisted transaction. In some embodiments, server 104 can receive an order (i.e., a list of products to be purchased) from an employee device and can concurrently receive payment requests from various customer devices. Server 104 can provide the list of customers who have submitted payment requests to the employee device, allowing the employee to associate the customer with the order. Server 104 can then process a payment transaction for the order with the correct customer device. Examples of such transactions are described below.

It will be appreciated that server 104 is illustrative and that variations and modifications are possible. While a server has been described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

The various programs described above, as executed, can have the effect of configuring a number of interoperating logic modules within server 104 to support self-service and/or assisted purchase transactions, in which server 104 receives and responds to requests from a customer device and/or an employee device. Examples of such transactions will now be described.

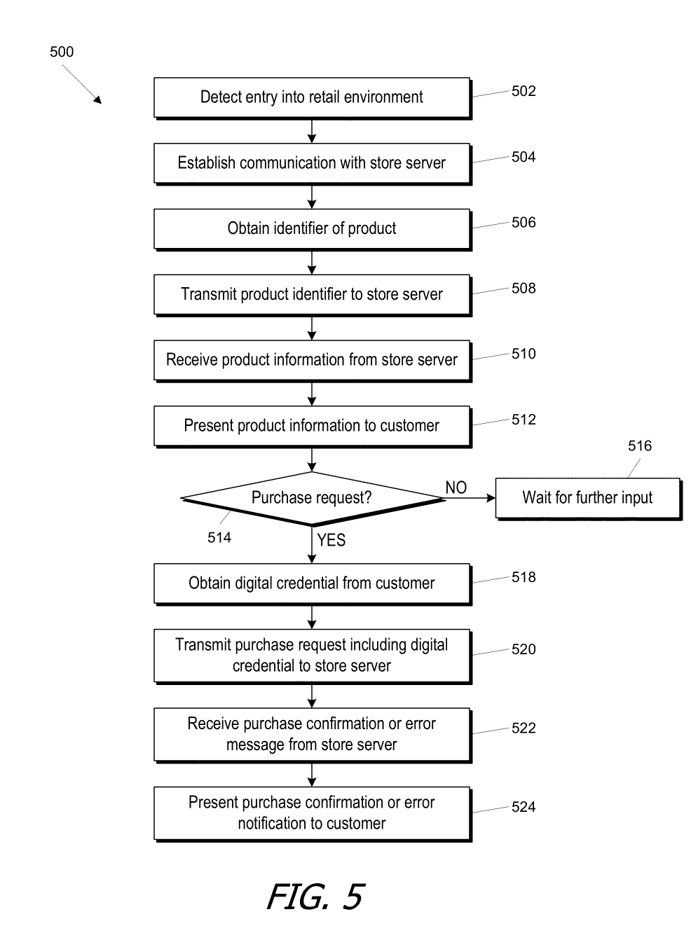

FIG. 5 is a flow diagram of a process 500 for using a customer device to purchase a product in a self-service transaction according to an embodiment of the present invention. Process 500 can be implemented, e.g., in customer device 106 of FIG. 2 executing retail app 216.

At block 502, customer device 106 detects entry into a retail environment (e.g., store 102 of FIG. 1). For example, a customer can launch retail app 216, and retail app 216 can include code to determine a current location of customer device 106, e.g., using a GPS receiver device incorporated into customer device 106, and compare the current location to a known location of store 102. In some embodiments, customer device 106 can detect when it is in range of wireless access point 105 associated with store 102 and can detect entry into the retail environment based on coming within range of wireless access point 105. In some embodiments, customer device 106 can be configured to detect entry into the retail environment regardless of whether retail app 216 is executing and can launch retail app 216 automatically upon detecting entry into the retail environment. In some embodiments, process 500 can execute only while customer device 106 remains in the retail environment; exiting the retail environment can cause process 500 to terminate.

At block 504, customer device 106 can establish a connection with a store server (e.g., server 104 of FIG. 4). This can be a wireless connection established via access point 105 or any other type of connection. As noted above, in some embodiments, entry into the retail environment can be detected based on establishing this connection; thus, blocks 502 and 504 can be combined into a single operation.

At block 506, customer device 106 can obtain an identifier of a product offered for sale in the store. For example, camera 212 can be used in connection with code reader app 218 to collect an image of a product identification symbol located on the product package (or in some cases on the product itself) and to analyze the image in order to determine the product identifier. Various product identification symbols can be used, such as one-dimensional or two-dimensional bar codes, QR (Quick Response) codes, alphanumeric character codes, holographic identification symbols, or the like. The identifier can be, e.g., a universal product code number, SKU (stock keeping unit) number, model number, serial number, or the like. Any image processing techniques can be incorporated to extract the product identifier from an image containing the visual identification symbol. At block 508, the product identifier can be transmitted to store server 104.

In other embodiments, customer device 106 can capture an image of the product or its identification symbol, e.g., using camera 212, and can send that image to store server 104 for analysis. Store server 104 may include reference images of one or more products. Upon receipt of the product image from customer device 106, store server 104 may use proprietary image recognition and matching algorithm to analyze the received image and compare it to the one or more stored images. If a match is found for the received image, store server may determine the product identifier associated with the product and either retrieve the product information from a local storage or send the product identifier to server 114 and receive product information from server 114. In some embodiments, the image recognition and matching can be performed by store server 104. In other embodiments, store server 104 may send the image to server 114 for analysis and receive product information from server 114 based on the image analysis performed by server 114. In this instance, server 114 includes the image recognition and matching algorithm.

At block 510, customer device 106 can receive product information from store server 104. The information, which can be sent in response to the transmission of the product identifier, can be specific to the product identified at block 506 and can include product specifications and options, product reviews, pricing information, and any other product-related information. In some embodiments, the pricing information can include a total purchase price for the product, incorporating any applicable taxes, transaction fees, and/or discounts.

At block 512, the received product information can be presented to the customer. In some embodiments, the presentation can be interactive. For example, summary information can be presented along with control prompts (e.g., virtual buttons on a touchscreen display) that the user can actuate to obtain additional information. The presented information can include a control prompt that the customer can actuate to indicate a desire to purchase the product. In some embodiments, audible prompts and voice responses can be used in addition to or instead of visual and/or tactile prompts and controls.

At block 514, customer device 106 can determine whether the customer has indicated a desire to purchase the product, e.g., by actuating the appropriate prompt or speaking an appropriate instruction. If not, process 500 can wait for further input from the customer at block 516. For example, on a touchscreen display the customer can touch a virtual button to obtain additional product information, indicate a desire to input a new product identifier, or invoke other functions of retail app 216. Depending on the particular input received, customer device 106 can respond by returning to the appropriate block of process 500 or exiting process 500.

If, at block 514, customer device 106 determines that the customer has indicated a desire to purchase the product, customer device 106 can initiate a self-service purchase transaction. For example, at block 518, customer device 106 can prompt the customer to enter a digital credential associated with account data server 116 (FIG. 1), and the customer can enter the credential. In some embodiments, customer device 106 can maintain a stored version of the credential, and block 518 can include confirming that the customer intends to use the stored credential for the purchase. In some embodiments, the digital credential can include multiple parts, e.g., a user identifier (user ID) and a password, and the customer device can store part of the credential (e.g., the user ID) and prompt the customer to supply the other part (e.g., the password) at block 518.

At block 520, customer device 106 can transmit a purchase request, including the digital credential and the product identifier, to store server 104. Store server 104 can use the digital credential to complete a purchase transaction; an example of a process that can be used by store server 104 is described below. When the transaction is complete, customer device 106 can receive (at block 522) a purchase confirmation message from store server 104; if the transaction fails, customer device 106 can receive an error message instead. The confirmation message can include an indication that the transaction completed successfully and a confirmation of the amount paid, as well as identification of the purchased product. In some embodiments, the confirmation can include an electronic receipt in a printable or displayable format.

At block 524, customer device 106 can present the purchase confirmation or error message to the customer. In the event of an error, customer device 106 can prompt the customer to retry the purchase or request employee assistance. In the event of success, the customer is free to leave the store.

In some embodiments, it may be desirable for customer device 106 to leave the transaction confirmation displayed until the customer clears it, and it may be desirable for customer device 106 to provide ready access to view confirmations of completed transactions, at least until customer device 106 has left the store. If desired, the display of a confirmation on customer device 106 can be used by store employees to verify that the customer purchased a particular product, in order to deter theft in an environment where self-service transactions using a customer device are permitted.

In some embodiments, a security transmitter can be implanted in a product or its packaging, with transmitters for different items transmitting different security codes. Each purchase can be associated with the particular security code of the item(s) purchased, and the store's alarm system can be configured not to activate an alarm if an item whose security code is known to belong to a purchased item is detected leaving the store. (For example, the alarm system can communicate with server 104 to determine whether a particular item has been purchased.)

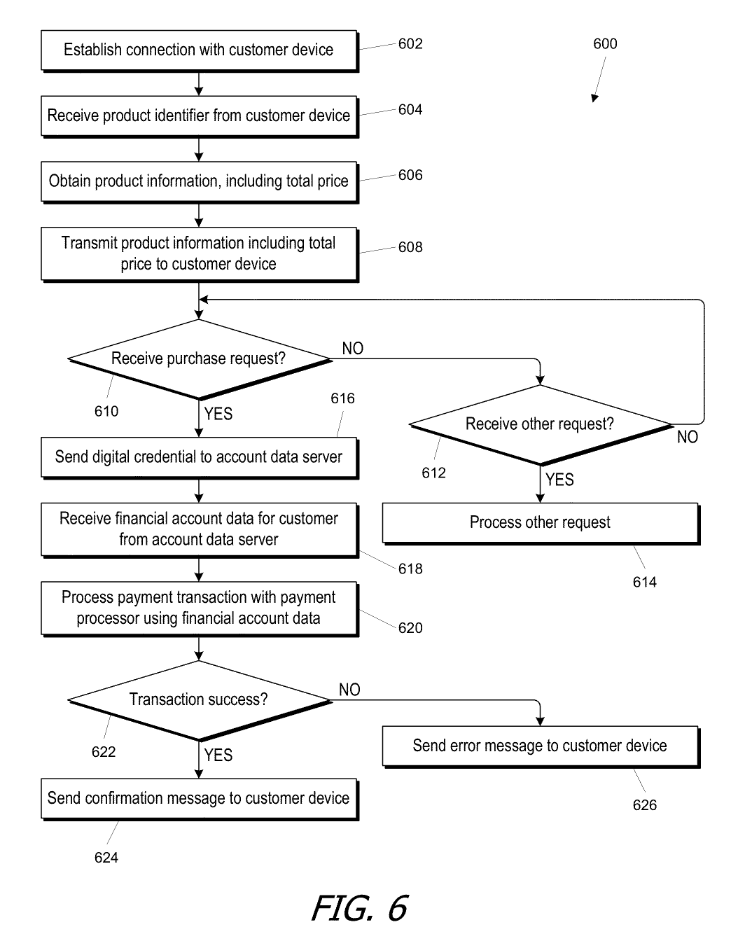

As indicated above, customer device 106 can perform a self-service purchase transaction by communicating with a server such as store server 104. FIG. 6 is a flow diagram of a process 600 for facilitating a self-service transaction according to an embodiment of the present invention. Process 600 can be performed, e.g., by store server 104 of FIG. 4.

At block 602, store server 104 can establish a connection with a customer device (e.g., device 106 of FIG. 2). The connection can be via a wireless communication channel and can be a secure connection to prevent interception of sensitive personal data (such as the customer's digital credential).

At block 604, store server 104 can receive a product identifier from customer device 106. The product identifier can be any coded value or other identifier that distinguishes a particular product from products of a different type; the identifier can be unique at the level of product models or more specific (e.g., unique to an individual item) as desired. In some embodiments, the product identifier is sufficiently product-specific to allow store server 104 to determine the price of the product.

At block 606, store server 104 can obtain product information, including a total price for purchasing the product. In some embodiments, store server 104 can obtain some or all of the product information from product data server 114 (FIG. 1), which can be located remotely from the store (e.g., at a central office of the business entity that owns store 102). In some embodiments, store server 104 can maintain at least some product information locally, and a separate product data server is not required. In some embodiments, block 606 includes determining the total price to be paid for purchasing the product; this amount can include the list price of the product, less any applicable discounts (e.g., sale pricing), plus applicable taxes (e.g., sales taxes, excise fees, etc.). In systems where store 102 is part of a chain, taxes and discounts can be applied on a per-store basis, so the total price can depend on which store 102 a particular customer is in. At block 608, store server 104 can transmit some or all of the product information to customer device 106.

At block 610, store server 104 can determine whether customer device 106 has transmitted a purchase request. If not, at block 612, store server 104 can determine whether customer device 106 has transmitted a different request, such as a request for more information about the product or a request for information about a different product. If a different request is received, that request can be processed at block 614. Depending on the particular request, block 614 can include returning to an earlier block of process 600 or exiting process 600.

If a purchase request is received, the purchase request can include a digital credential and the product identifier. (In some embodiments, store server 104 can associate a purchase request from a particular customer device with the last product whose identifier was received from that device, and the purchase request need not include the product identifier.) At block 616, store server 104 can send the digital credential to account data server 116.

Account data server 116 can use the digital credential to look up financial account information for the customer. For example, the digital credential can include a user ID and password, and account data server 116 can use this information to locate the appropriate user account record 122 and read the associated credit card information from that record. In some embodiments, each user account maintained by account data server 116 has a unique user ID, and the password is used to confirm that the customer is authorized to access the user account.

In some embodiments, additional security measures can be implemented. For example, user account record 122 can include a device identifier for a mobile device known to belong to an authorized user of the account. Store server 104 can receive a device identifier from customer device 106 and can send the device identifier along with the digital credential to account data server 116; account data server 116 can use the received device identifier to verify whether the request originated with the authorized user's device.

As another example, in some embodiments, an authorized user of a particular user account can choose whether to allow in-store transactions through that account, e.g., by configuring account settings when logged into the account. (For example, a parent can use these settings to prevent a child from using an account to make in-store purchases.) If user account record 122 indicates that in-store transactions are not allowed, account data server 116 can so notify server 104 when a request for financial account information is received; if transactions are not allowed, account data server 116 can decline to provide the financial account information to store server 104. In some instances, a user may be able to set dollar limits or other restrictions on in-store purchases via user account settings, and account data server 116 can notify server 104 of any such restrictions.

At block 618, store server 104 can receive financial account information for the customer from account data server 116. As described above, account data server 116 can implement security measures to verify that the customer is authorized to access the user account, and if the verification fails or if in-store purchasing is blocked for the user account, store server 104 can receive an error message instead of the financial account information. This in turn can result in customer device 106 receiving an error message at block 522 of process 500.

Assuming the financial account information is received at block 618, then at block 604, store server 104 can process a payment transaction using the financial account information. The payment transaction can be processed by communicating with payment processing server 118. As described above, block 618 can include conventional payment transaction processing, and payment processing server 118 need not be aware that store server 104 obtained the financial account information from account data server 116 rather than directly from the customer.

At block 622, store server 104 can determine whether the payment transaction was processed successfully. If so, then at block 624, store server 104 can send a confirmation message to customer device 106. If not, then at block 626, store server 104 can send an error message to customer device 106.

In some embodiments, it may be desirable not to permit self-service purchase transactions on all products available at store 102. For example, permitting self-service purchase of high-price products may present an unacceptable risk of loss to the store. In some instances, it may be desirable to make sure that the customer consults with an employee before purchasing a product (e.g., to help the customer select the most appropriate product for her needs or to help configure the product for the customer's use). In some instances, a customer may have requested to have in-store purchasing blocked on a particular device. Accordingly, store server 104 can be configured to selectively permit or block self-service purchasing.

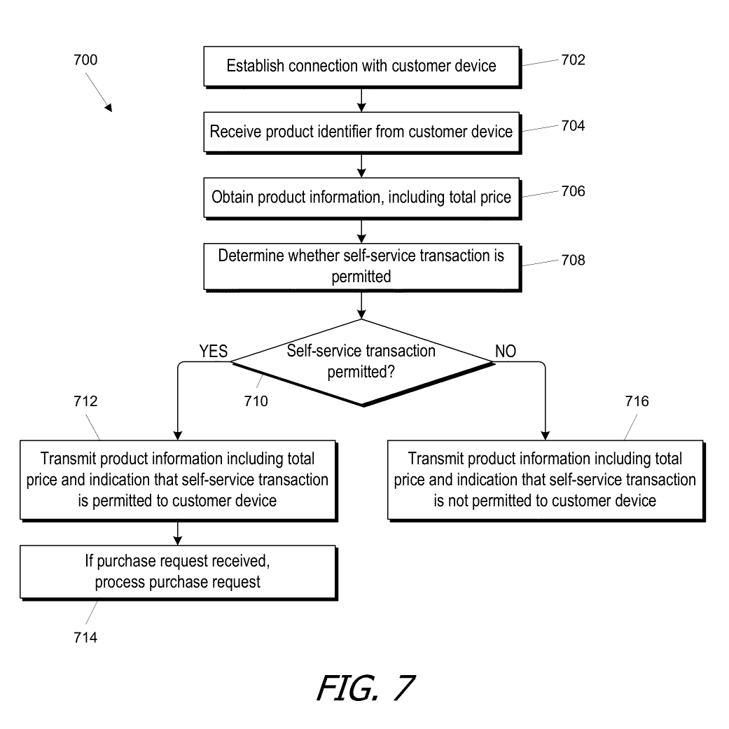

FIG. 7 is a flow diagram illustrating a modification to process 600 of FIG. 6 that can be used by a server (e.g., store server 104) to selectively permit or block self-service transactions according to an embodiment of the present invention. Blocks 702, 704 and 706 can be generally similar to blocks 602, 604, and 606 of process 600 described above.

At block 708, store server 104 can determine whether a self-service purchase transaction is permitted for the product identified at block 704. The determination can be based on decision rules. In some embodiments, decision rules can be locally imposed by server 104 In some embodiments, some or all decision rules can be imposed at a higher level, e.g., by product information data store 114, with a final decision resulting from applying the rules being communicated to store server 104, along with other product information.

Various decision rules can be defined and applied. For example, one decision rule can be based on the product identifier. Certain products may be excluded from self-service purchase. As just one example, a retailer selling mobile phones may prefer to have an employee assist the customer with setting up and activating a new phone; accordingly, the retailer can block self-service purchase of mobile phones while allowing self-service purchase for other products, such as mobile phone cases and other accessories. Thus, one decision rule can include a list of product identifiers that are to be excluded from self-service transactions (or a list of product identifiers for which self-service transactions are permitted); the rule can be applied by searching for a match between the product identifier received from customer device 106 and a product identifier on the excluded (or permitted) list.

Another decision rule can be based on the total price of the transaction. For example, self-service transactions may be permitted only if the total price (including taxes) is below a threshold set by the retailer, e.g., $50, $100, $500, or any other desired threshold. In some embodiments where multiple stores 100 are centrally managed, the threshold can be set on a per-store basis.

Another decision rule can be used to enable or disable self-service purchasing on a per-store basis. Thus, for example, if self-service purchasing has created problems related to theft in a certain store, the store can simply disable the feature.

Another decision rule can be based on the particular customer device being used. In some embodiments, if the device does not have sufficient hardware or software to communicate the transaction data, self-service transactions can be disabled for that device. For example, in some implementations, self-service transactions are permitted only for products where the customer device can scan a barcode by capturing and analyzing an image of the barcode. Some customer devices may have cameras with insufficient resolution to reliably capture barcode images or insufficient processing resources to analyze the image in a reasonable amount of time, and self-service purchase can be blocked on such devices. As another example, if a particular customer device is known to have been stolen, use of the device for self-service purchases can be blocked (and store security can be notified if such use is attempted).

It is to be understood that multiple decision rules can coexist, with each rule serving independently as a veto on the decision to allow a particular self-service transaction. Any combination of the above decision rules and/or other decision rules can be implemented.

Referring again to FIG. 7, at block 710, if a self-service transaction is permitted, then at block 712, store server 104 can transmit an indication to this effect, along with other product information, to customer device 106. Thereafter, the customer can initiate a purchase request, which can be received and processed by store server 104 at block 714; the processing can be similar or identical to that described above with reference to process 600. If, at block 710, a self-service transaction is not permitted, then at block 716, store server 104 can transmit an indication to this effect, along with other product information, to customer device 106. In this case, customer device 106 can prompt the customer to request employee assistance to purchase the product or direct the customer to go to a checkout stand in the store in order to purchase the product.

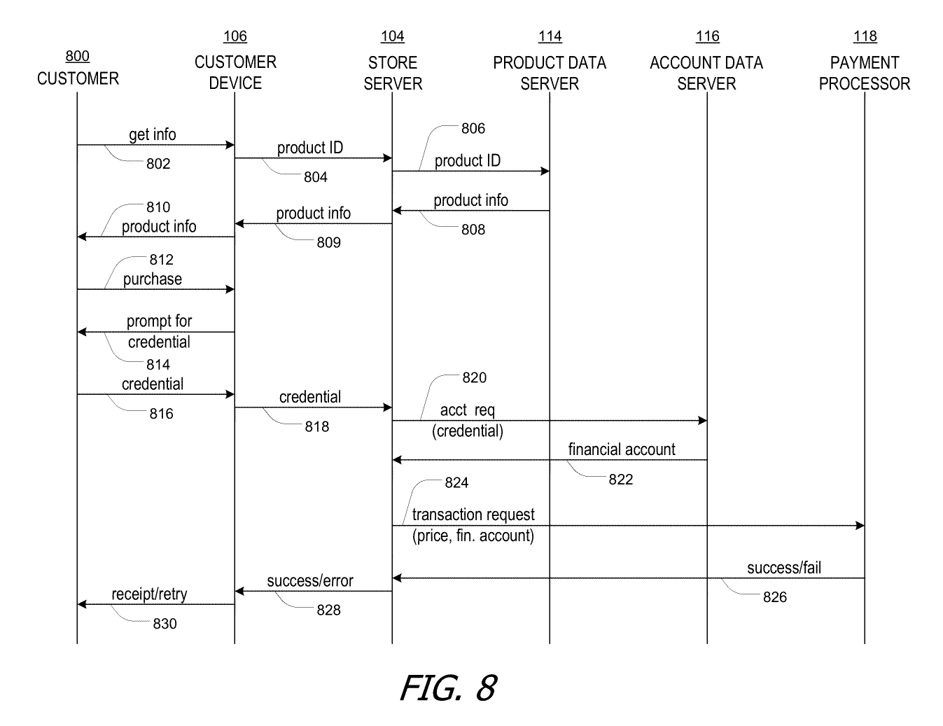

Processes 500, 600 and 700 can be used cooperatively by a customer device and a server to complete a self-service purchase transaction. FIG. 8 is a message passing diagram further illustrating interaction between participating entities in a self-service purchase transaction according to an embodiment of the present invention. In this embodiment, a customer 800 operates a customer device 106 to purchase a product. Customer device 106 communicates with store server 104, which in turn communicates with product data server 114, account data server 116, and payment processor 118 to complete the purchase transaction.

Customer 800 can initiate the transaction by instructing customer device 106 to obtain a product identifying information (message 802). Customer device 106 can obtain a product identifier (product ID), e.g., by scanning a barcode or other visual identification code to extract the product ID, which it communicates to store server 104 (message 804). Store server 104 can communicate the product ID to product data server 114 (message 806) and receive product information (message 808), including price information, in response. Store server 104 can communicate some or all of the product information, including the price information, to customer device 106 (message 809), which presents the information to customer 800 (message 810).

If customer 800 decides to purchase the product, she can indicate her desire to customer device 106 (message 812). In response, customer device 106 can prompt customer 800 to enter a digital credential associated with the customer's user account on account data server 114 (message 814). For example, customer device 106 can provide the user ID for the user account and prompt customer 800 to enter the password. In response, customer 800 can enter the credential (message 816). Customer device 106 can forward the credential (e.g., user ID and password) to store server 104 (message 818). Store server 104 can send an account-information request (message 820) to account data server 116; message 820 can include the digital credential provided by customer device 106.

Account data server 116 can access account record 122 for the identified user account and can return associated financial account information (e.g., a credit card number or other account number and related information such as a security code, expiration date, billing address, or the like) to store server 104 (message 822). In some instances, the returned information can also include user-specific information such as limits on the number or monetary amount of in-store purchases. In some instances, account data server 116 can determine that access to the requested financial account information should be denied. For example, the user account might not be associated with any financial account, or the user may have indicated that the user account is not to be used for in-store purchases. In that case, account data server 116 can return an error message (not shown in FIG. 8) indicating that the requested information cannot be provided.

After receiving the financial account information, store server 104 can send a payment transaction request to payment processing server 118 (message 824). This request can include any data that may be of use in processing the payment transaction, including an identifier of store 102 as a merchant, the customer's financial account information, the purchase amount, and/or other transaction details such as identification of particular products purchased or general product categories or the like. Payment processing server 118 can process the request and respond with a success or failure notification (message 826).

In some embodiments, if financial account information (message 822) is not received by store server 104, store server 104 does not send the payment transaction request (message 824) to server 118; instead, server 104 can simply proceed to notify the customer of the error by sending an error message (message 828).

When the payment transaction is completed (successfully or not, as the case may be), store server 104 can send a success or error message (message 828) to customer device 106, which can present the message to customer 800 (message 830). For example, if the transaction is successful, customer device 106 can present a receipt image. If the transaction failed, customer device 106 can prompt the customer to retry the purchase or to request assistance from a store employee to complete the purchase. In some instances, in the event of error or failure, message 828 can indicate the nature of the error (e.g., whether the digital credential was not recognized or whether the transaction was denied by the processor or whether the user account does not permit use for in-store transactions), and the customer can be prompted appropriately depending on the nature of the error.

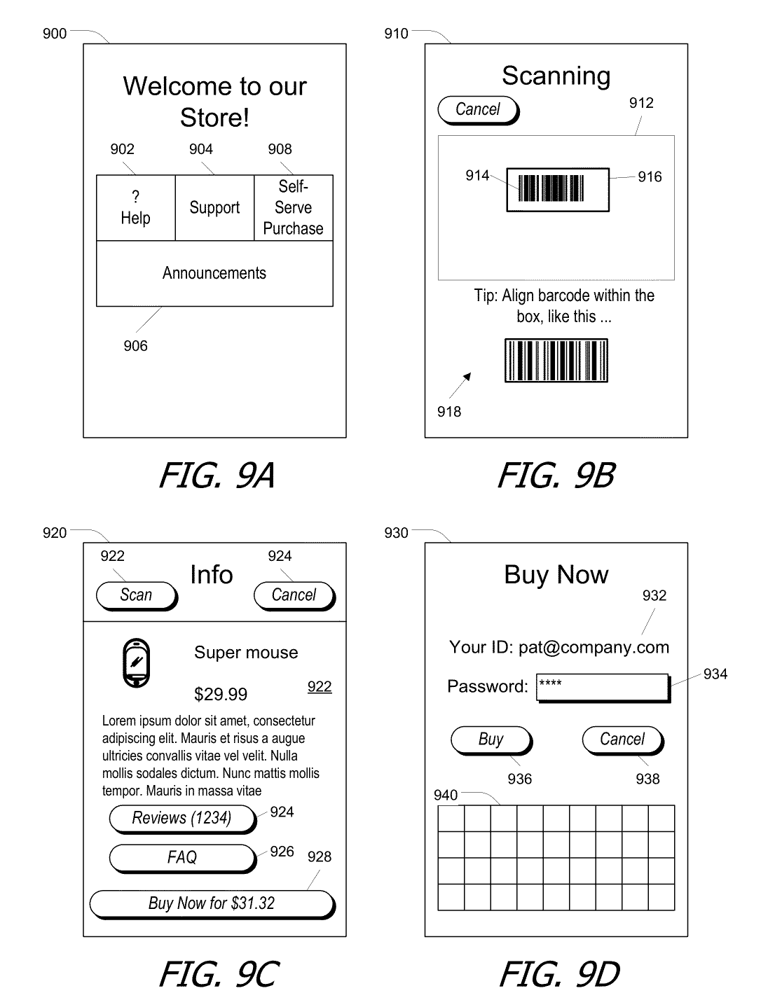

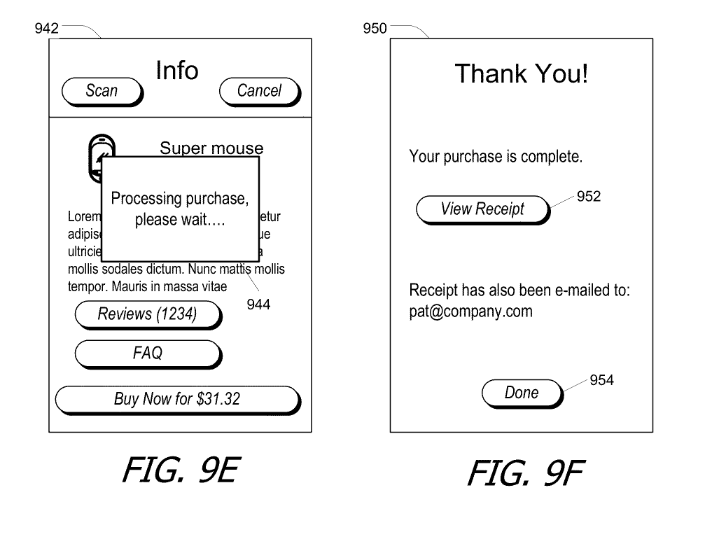

A further understanding of the customer experience of a self-service transaction can be had by reference to FIGS. 9A-9F, which illustrates a sequence of screen images for customer device 106 corresponding to different stages in a self-service transaction according to an embodiment of the present invention. In these examples, it is assumed that customer device 106 provides a touch-screen display, and the customer can touch areas of the screen in order to activate various functions.

FIG. 9A illustrates an initial screen 900 associated with a retail-store application (e.g., retail app 216). Initial screen 900 can identify the store and offer various options, such as requesting employee help (button 902), accessing technical support services (button 904), viewing store-related announcements (button 906), and making a self-service purchase (button 908).

FIG. 9B illustrates a scanning screen 910 that can be displayed if the customer selects button 908 from screen 900 to initiate a self-service purchase. In this embodiment, when the customer selects button 908, code reader app 218 is invoked; code reader app 218 can activate camera 212 in video mode (or any other mode that supports automatically capture of sequential images at a desired frame rate, e.g., at least 1 frame per second) to attempt to read a product identification code (in this example, a bar code). Scanning screen 910 in this embodiment includes a real-time display 912 that shows information about the image the camera is detecting. In this example, the image has been cropped to only show a portion 914 of the detected image that is recognized by code reader app 218 (e.g., based on image analysis algorithms) as a barcode; all other image areas in real-time display 912 can be dark. A guide box 916 is provided to encourage the customer to adjust the position of customer device 106 relative to the product until bar code image 914 is aligned with guide box 916. The lower portion of scanning screen 910 can provide a prompt 918 to help the customer understand the process.

In some embodiments, while scanning screen 910 is displayed, the customer can move customer device 106 and/or the product being scanned until such time as code reader app 218 obtains a satisfactory reading of the barcode. For example, code reader app 218 can continually attempt to read (i.e., employ various algorithms to detect and interpret) a barcode from images provided by camera 212. If the algorithms do not indicate a satisfactory reading (e.g., based on a reliability score as known in the art), code reader app 218 can modify the displayed image 912 so as to suggest an action the customer can take to improve the reading. For example, if it is determined that the bar code is too far away, bar code image 914 can be drawn smaller than guide box 916, which suggests to the customer to bring the product and the camera closer together. If it is determined that the bar code is too close, bar code image 914 can be drawn larger than guide box 916, which will suggest to the user to move the product and the camera apart. Left/right and up/down alignment can be guided similarly, by placing bar code image 914 in an appropriate position relative to guide box 916 within real-time display 912. In some embodiments, the size and position of guide box 916 are held constant within real-time display 912 during this process, and the bar code image 914 is scaled and positioned appropriately to provide visual feedback.

In some embodiments, when a good reading is obtained, real-time image 912 can be modified to indicate success. For example, a “laser” line can be drawn across bar code image 914, and/or bar code image 914 can be artificially brightened, or the screen can flash. Any recognizable visual cue can be used. In some embodiments, an audio cue (e.g., a beep) can be used in addition to or instead of visual cues.

Once the barcode is successfully read, customer device 106 can obtain product information, e.g., by exchanging messages with store server 104 as described above. FIG. 9C illustrates a product information screen 920 that can be used to present received product information to a customer. Product information screen 920 can include control prompts such as scan button 922, which the customer can touch to return to scanning screen 910 and cancel button 924, which the customer can touch to return to initial screen 900.

Product information screen 920 can also include a basic product information area 922, which can display information such as a product image, name, price and description. In some embodiments, area 922 can be scrollable to present more information

Product information screen 920 can also include options to read reviews (button 924), obtain answers to common questions (button 926), or purchase the product (button 928). In this example, purchase button 928 shows the total price to be paid, after accounting for applicable taxes, sale prices or other discounts, etc.

FIG. 9D illustrates a purchasing screen 930 that can be displayed if the customer selects purchase button 928 from screen 920. Purchasing screen 930 in this example displays a user ID 932 for the customer's user account (in this example, the user ID is already stored in customer device 106) and a password prompt 934, where the customer can enter a password, e.g., via a virtual keyboard 940. When the password is entered, the customer can touch buy button 936 to proceed with the purchase or cancel button 938 to cancel the purchase and return to product information screen 920.

FIG. 9E illustrates a processing screen 942 that can be displayed if the user selects buy button 936 from purchasing screen 930. In this embodiment, processing screen 942 provides an overlay message 944 indicating that the purchase transaction is being processed, on top of product information screen 920. In some embodiments, the various control options for product information screen 920 can be inactive while overlay message 944 is displayed. In some embodiments, processing screen 942 is first displayed when customer device 106 sends the purchase transaction request to store server 104 (e.g., as described above with reference to message 818 in FIG. 8) and continues to be displayed until a success or error message is received from store server 104 (e.g., as described above with reference to message 828 in FIG. 8).

FIG. 9F illustrates a completion screen 950 that can be displayed if the purchase transaction completes successfully. Screen 950 notifies the customer that the purchase is complete and provides a receipt button 952 that can be activated to display the receipt. In some embodiments, the receipt is also e-mailed to the customer's e-mail address, e.g., the address associated with the user account that was used to obtain the financial account information. Done button 954 allows the customer to return to initial screen 900.

It will be appreciated that the foregoing self-service transaction processes and devices are illustrative and that variations and modifications are possible. Process steps described as sequential may be executed in parallel, order of steps may be varied, and steps may be modified, combined, added or omitted.

In some embodiments, product identification codes are not limited to barcodes but may include QR codes, holographic codes, other codes based on line or spot patterns, character or symbol codes that can be interpreted using text or symbol recognition software, or the like. In other embodiments, a customer device can obtain a product identifier without using a visual code or a camera. For example, if the product package has an embedded transmitter (e.g., a near-field communication transmitter or Bluetooth LE transmitter) that transmits an identification code, the customer device can be configured to receive this transmission and extract the identification code. In other embodiments, the customer can enter a product identification code, e.g., by reading characters from the product package and entering them via a user interface of the customer device. In still other embodiments, the customer can take a photo of the product, and the photo can be compared to products offered for sale to identify the product. If a unique match is not found, a list of candidates can be presented to the customer. In some embodiments, such image analysis and comparison can be performed by the customer device, or the customer device can transmit the photo to the store server, which can perform the analysis and comparison.

Further, the processes described above refer at times to a single product being purchased. In some embodiments, a customer can purchase multiple products in a single self-service transaction. For instance, referring to FIG. 9C, in addition to or instead of the option to buy now (button 928), the product information screen can provide an option to add the product to an “order” for the customer. The customer can then scan other products and add them to the order. When the customer indicates to the customer device that she has finished adding products to the order, she can be prompted to pay the total price of the order in a single purchase transaction (assuming the total price or number of items does not exceed applicable limits on in-store self-service purchases).

In some embodiments, the retail app on the customer device can determine whether the device has sufficient hardware and/or software resources to complete a self-service transaction and can disable user-interface features related to self-service transactions if sufficient resources are not present. For example, if the device has no camera or a camera of insufficient resolution to support reading of product identifiers, the self-service transaction features can be disabled. User interface screens can be modified to indicate whether a self-service transaction is or is not available. For example, buttons associated with self-service transactions (e.g., buy button 928 in FIG. 9C) can be omitted from the screen or rendered in a faded format or with another visual effect to indicate that they are inactive. In some embodiments, buttons associated with self-service transactions can be replaced with other buttons or instructions (e.g., requesting employee assistance) if a self-service transaction is not available.

As described above, a self-service transaction can be performed using a customer device (e.g., customer device 106) communicating with a server (e.g., store server 104) without involving an employee or an employee device. In some embodiments, it may be useful to provide employees with real-time information about self-service purchasing activity. Accordingly, in some embodiments, store server 104 can send a “self-service dashboard” to employee devices 108, either at periodic intervals or in response to requests from employees operating employee devices 108. The self-service dashboard can include information about the customers making purchases (e.g., a customer identifier provided to store server 104 by customer mobile device 106) and/or the products being purchased and can indicate the current status of each transaction (e.g., “scanning,” “processing payment,” “transaction canceled,” “transaction completed,” or “error”). The dashboard view need not include full transaction details—e.g., financial account or price information. In some embodiments, the employee can select a transaction from the dashboard view to obtain additional information.

In some embodiments, transactions can be maintained on the dashboard for some time period after completion (e.g., 5 minutes), to provide employees with ready access to information about recently completed transactions. Some embodiments can also provide a “historical” dashboard view, e.g., to allow employees to view transactions completed earlier in the day.

The information can be presented by employee device 108 in various formats. For example, a scrolling marquee (e.g., in a bar at the top or bottom of a display screen of employee device 108) can provide continuous updates, and employee in some embodiments the employee can interact with the marquee, e.g., to pause or reverse the scrolling, or to tap on a currently displayed transaction to view more information. In some embodiments, the dashboard view can present a list of transactions that can be arranged, e.g., by status or by time of initiation. By monitoring transaction status, employees can identify and assist customers who may be having problems with a self-service purchase (e.g., based on whether the transaction has been in progress for an unusually long time or whether errors are occurring).

In some embodiments, the dashboard can be used to facilitate purchase verification. For example, employees can use the dashboard view to confirm that a customer observed to be leaving the store with a product actually did purchase the product, without having to ask the customer to present a receipt. In some embodiments, the dashboard view may include product images to help the employee quickly recognize a product that is leaving the store. As another example, in some embodiments, the employee can select a completed transaction from the dashboard and view or print a receipt (e.g., in response to a customer request). As yet another example, if an unexpected error occurs during a transaction (e.g., the customer's app crashes or communication with the store server is lost), an employee can consult the dashboard view to determine whether the transaction completed and inform the customer accordingly.

As described above, in some instances self-service purchase transactions might not be available for a particular item or within a particular store or due to limitations of the customer's mobile device, or a customer may prefer to consult with an employee prior to purchase. Some embodiments of the present invention provide employee-assisted transactions where payment is made using the customer's mobile device as a source of account information. Similarly to the embodiments above, the customer can use her mobile device to provide a digital credential that in turn can be used to identify a financial account associated with the customer, and the purchase price can be charged to that account. In the case of an employee-assisted transaction, an employee device (e.g., employee device 108 of FIG. 1), rather than a customer device, can provide to the store server information identifying the product (or products) to be purchased. Examples related to employee-assisted transactions will now be described.

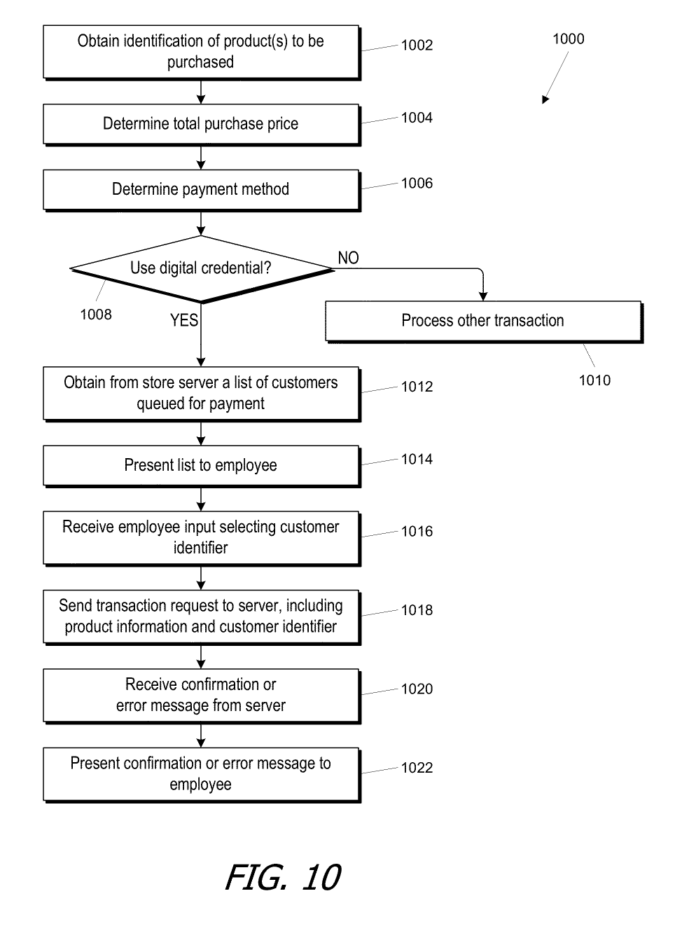

FIG. 10 is a flow diagram of a process 1000 for performing an employee-assisted purchase transaction according to an embodiment of the present invention. Process 1000 can be implemented, e.g., in employee device 108 of FIG. 3 executing employee app 316. At block 1002, employee device 108 can be used to obtain product identifiers from one or more products to be purchased in the customer's order. (An order can include one or more products.) In some embodiments, employee device 108 can execute code reader app 318, which can be similar to code reader app 216 on a customer device as described above. For instance, a screen similar to scanning screen 910 can be implemented on employee device 108.

At block 1004, the total purchase price is determined. In some embodiments, employee device 108 can transmit product identifiers to store server 104 and receive price information in response, somewhat similarly to the processes described above by which price information can be delivered to a customer device in a self-service transaction. The total purchase price can include the list price of all products in the order, adjusted for sale prices, other discounts, applicable taxes, etc.

At block 1006, employee device 108 can determine the payment method the customer intends to use. In some embodiments, the customer can select from multiple payment methods including cash, purchase card, gift card, or purchase using a digital credential. In some embodiments, to determine the payment method, the employee can ask the customer and input information corresponding to the answer into employee device 106.

At block 1008, employee device 108 can determine whether payment method using a digital credential is selected. If any other method is selected, employee device 108 can process a transaction using the selected method at block 1010.

If, at block 1008, payment using a digital credential is selected, then employee device 108 proceeds to associate the order with the customer device. For example, at block 1012, employee device 108 can communicate with store server 104 to obtain a list (referred to herein as a payment queue) of customers who have signaled their intent to use their mobile devices to pay for products in employee-assisted transactions. At block 1014, employee device 108 can present the payment queue to the employee, who can determine if the name of the customer he is assisting appears on the list. If not, employee device 108 can communicate with store server 104 to refresh the list periodically, repeating blocks 1012 and 1014.

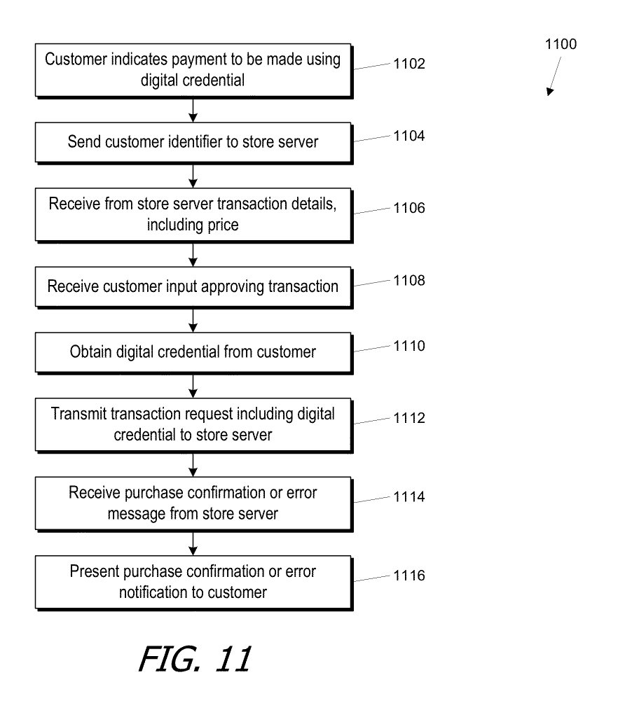

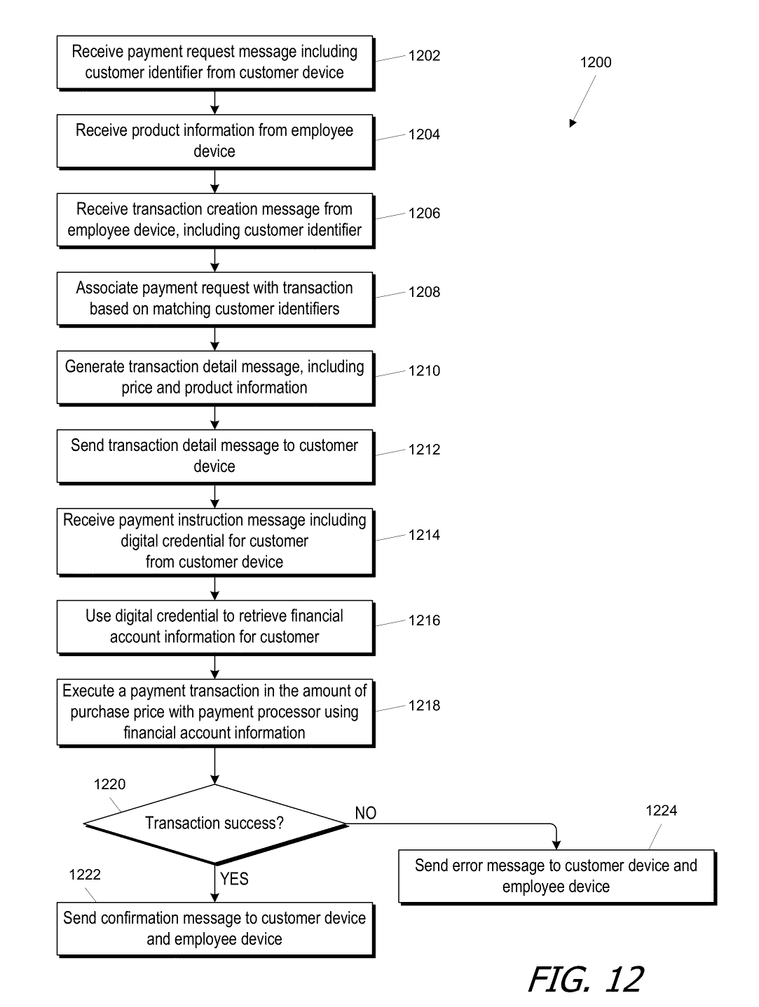

While this is happening, the customer can be operating her mobile device to indicate that she wants to complete an employee-assisted transaction. This process, described below with reference to FIGS. 11 and 12, occurs between the customer's device and store server 104 and results in the customer's name (or some other recognizable identifier) being added to the payment queue by store server 104. Thus, in due course, the customer's name can appear in the displayed payment queue on employee device at block 1014.

Once the customer's name has appeared, the employee can select the customer's name from the payment queue at block 1016. At block 1018, employee device 108 can send a transaction request to store server 104; the transaction request can include the selected customer's name and information about the order (e.g., a list of products in the order or a reference to earlier-supplied product information for the order). In some embodiments, a particular employee device 108 can only have one employee-assisted transaction order in progress at a time. As employee device 108 adds products to an order, store server 104 can save the information about each product added in association with an identifier of the employee device 108 that sent the information; when employee device 108 subsequently sends a customer name (or other customer identifier), that name becomes associated with the saved product information for the order. Thus, it is not necessary for employee device 108 to send product information for an order to store server 104 twice.

After the customer identifier has been sent and associated with the product being purchased, employee device 108 can wait while store server 104 completes the purchase transaction (e.g., as described below). Once the purchase transaction is complete, employee device 108 can receive a confirmation or error message from store server 104 at block 1020 and can present the message to the employee at block 1022.

In process 1000, employee device 108 need not receive the customer's digital credential. Instead, the customer in an employee-assisted transaction can provide the digital credential to store server 104 directly from her own device. FIG. 11 is a flow diagram of a process 1100 for performing an employee-assisted transaction according to an embodiment of the present invention. Process 1100 can be implemented on a customer device (e.g., device 106 of FIG. 2).

At block 1102, the customer can indicate to customer device 106 that payment for a purchase is to be made using the customer's digital credential. For example, retail app 216 can provide a screen from which the customer can select a button requesting to be added to the payment queue maintained by store server 104. In response, at block 1104, customer device 106 can transmit a customer identifier to store server 104. The identifier can be, for example, the customer's name as previously programmed into device 106 by the customer, an e-mail address associated with the customer, a phone number associated with the customer (e.g., with customer device 106), a handle or alias selected by the customer, or any other identifier that is likely to be recognized by the customer and unique among customers in a given store at a given time.

In some embodiments, when server 104 receives the customer identifier, this triggers adding the identifier to the payment queue, which in turn results in the identifier appearing on employee device 108 and the employee selecting the identifier to be associated with a specific transaction as described above with reference to FIG. 10. Store server 104 can then send transaction details to customer device 106.

At block 1106, customer device 106 can receive the transaction details from store server 104. The transaction details can include the total purchase price and a list of items being purchased, so that the customer can verify that the correct transaction has been associated with her device. At block 1108, customer device 106 can receive input from the customer confirming the transaction. At block 1110, customer device 106 can obtain a digital credential for the customer. Obtaining the digital credential can proceed in the same manner as in a self-service transaction (e.g., prompting the customer to enter a user ID and/or password as described above). In some embodiments, blocks 1108 and 1110 can be accomplished by prompting for and obtaining the digital credential.

At block 1112, customer device 106 can transmit a purchase transaction request, including the digital credential, to store server 104. Store server 104 can then complete the purchase transaction in a manner similar to that described above for self-service transactions. For example, server 104 can use the customer's digital credential to obtain financial account information for the customer from account server 116, then use the financial account information to process a payment transaction with payment processing server 118.

Upon completion of the payment transaction, customer device 106 can receive a purchase confirmation or error message from store server 104 at block 1114 and can present a corresponding notification to the customer at block 1116.

In process 1100, customer device 106 need not establish any communication channel or communicate information with employee device 108. Instead, store server 104 creates a temporary association based on information received separately from the two devices, allowing store server 104 to process a purchase transaction and inform both devices of the result. FIG. 12 is a flow diagram of a process 1200 for processing an employee-assisted purchase transaction by a server (e.g., store server 104) according to an embodiment of the present invention. Process 1200 can be used in conjunction with an employee device 108 executing process 1000 of FIG. 10 and a customer device 106 executing process 1000 of FIG. 10.

At block 1202, store server 104 can receive a payment request message, including a customer identifier (e.g., the customer's name) from customer device 106. This can be, e.g., the information sent at block 1104 of process 1000 described above. In some embodiments, in response to receiving the payment request message, store server 104 can add the customer's name to a payment queue.

At block 1204, store server 104 can receive product information identifying the product (or products) to be purchased from employee device 108. At block 1206, a transaction creation message from employee device 108; the transaction creation message can include the customer identifier.

In some embodiments, the transaction creation message and the information identifying the product to be purchased can be sent together by employee device 108. In other embodiments, the information identifying the product to be purchased can be sent first, e.g., as employee device 108 transmits product identifiers for an order, and the transaction creation message can be sent later. For example, as described above with reference to processes 1000 and 1100, store server 104 can maintain a payment queue (e.g., using payment queue program 424 of FIG. 4) and can present a payment queue that includes the customer's name to employee device 108; employee device 108 can indicate selection of the customer's name from the queue.

It should be noted that receiving the customer's name from customer device 106 can occur before or after or concurrently with receiving the product identifying information from employee device 108.

At block 1208, store server 104 can associate the payment request received from customer device 106 with the transaction creation message received from employee device 108, e.g., by matching the customer's name (or other identifier), which can be included in both requests. In embodiments described above, it is contemplated that server 104 receives the customer payment request before receiving the transaction creation request, as server 104 presents the customer's name to employee device 108 for use in generating the transaction creation request. However, in other embodiments, the employee can enter a customer identifier to be used in the transaction creation message, and server 104 can subsequently receive a matching customer identifier from customer device 106, triggering the association of the payment request with the transaction creation message. Thus, a payment request from a customer device and product or order information from an employee device can be received in any temporal sequence, provided that store server 104 can eventually associate the customer device with the order (i.e., the products to be purchased).

At block 1210, store server 104 can generate a transaction detail message that includes product identifying information and the price, and at block 1212, store server 104 can send the transaction detail message to customer device 106. This can include, e.g., the information received at block 1106 of process 1100 described above.

At block 1212, store server 104 can receive a payment instruction message from customer device 106. The message can include a digital credential for the customer, which can be obtained by customer device 106 as described above (e.g., at blocks 1010, 1012 of process 1000 of FIG. 10). At block 1216, store server 104 can use the digital credential to obtain financial account information for the customer. For example, as described above in the context of self-service transactions, store server 104 can obtain financial account information from account data server 116. At block 1218, store server 104 can use the financial account information to execute a payment transaction with payment processing server 118. These blocks can be implemented identically to corresponding blocks in the self-service transaction described above.

At block 1220, store server 104 can determine whether the transaction succeeded. If so, server 104 can send a confirmation message to customer device 106 and to employee device 108 at block 1222. If not, server 104 can send error messages to both devices at block 1224.

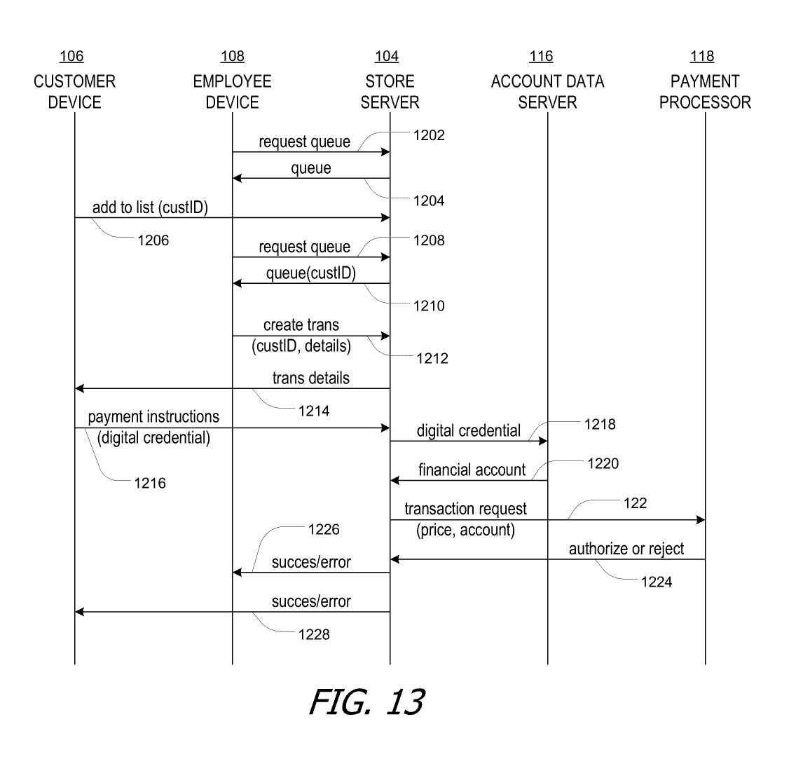

Processes 1000, 1100, and 12000 can be used cooperatively by an employee device, a customer device, and a server to complete an employee-assisted purchase transaction. FIG. 13 is a message passing diagram further illustrating interaction between participating entities in an employee assisted purchase transaction according to an embodiment of the present invention. (The customer and employee are not explicitly shown; their actions are implicit in the sequence of messages.)

In this example, employee device 108 may already have been used to scan a product (or products) to be purchased. Depending on the particular embodiment, employee device 108 can either store the product identifying information locally until a later stage in the process or employee device 108 can transmit product identifying information to store server 104 during scanning (not shown).

As illustrated in FIG. 13, employee device 108 can attempt to identify a customer to be associated with a transaction the employee is assisting. For example, employee device 108 can send a request to store server 104 for a current payment queue (message 1302), listing names of customers waiting to pay for employee-assisted purchases. Server 104 can return the current queue (message 1304). This request/response sequence can be repeated any number of times, either automatically or in response to manual input from the employee.

At some point (which can be before or after the first instance of messages 1302 and 1304), customer device 106 can send to store server 104 a request to be added to the payment queue (message 1306). The request can include the customer's name or any other customer identifier (e.g., as described above). In some embodiments, server 104 can send a confirmation message (not shown) to customer device 106.

After customer device is added to the payment queue, employee device 108 can again request the queue (message 1308). It should be noted that message 1308 need not be triggered in any way by message 1306; for example, message 1308 can be generated as a result of periodic polling by employee device 108 or refresh requests initiated by the employee. This time, when store server 104 returns the queue (message 1310), the customer's name can be included.

At this point, the employee can select the name and instruct employee device 108 to initiate the transaction. In response to this instruction, employee device 108 can send a transaction creation message (message 1312) to store server 104. This message can include the customer's name (or other customer identifier used in the payment queue). In some embodiments, the transaction creation message can include the product-identifying information previously gathered by employee device 108. In other embodiments, store server 104 has already received the product-identifying information from employee device 108 and associates that information with the customer identifier from the transaction creation message, thereby determining which customer device should be associated with the new transaction.

Having thus defined a transaction, store server 104 can send a transaction detail message (message 1314) to customer device 106. Transaction detail message 1314 can include the product identifying information, total amount due, and/or other information such as an identifier of the customer. Customer device 106 can present transaction details to the customer, confirm that the customer wishes to proceed, and obtain a digital credential (e.g., as described above with reference to process 1000). Thereafter, customer device 106 can send a payment instruction message (message 1316) to store server 104. Payment instruction message 1316 (like message 816 of FIG. 8 in the case of a self-service transaction) can include a digital credential for the customer.

Processing of the payment can involve a message exchange similar to that described above for self-service payments with reference to FIG. 8. For example, store server 104 can send an account-information request (message 1318) to account data server 116; message 1318 can include the digital credential provided by customer device 106.

Account data server 116 accesses user account record 122 for the identified user account and can return associated financial account information (e.g., a credit card number or other account number and related information such as a security code, expiration date, billing address, or the like) to store server 104 (message 1320). As described above, the returned information can also include user-specific information such as limits on the number or monetary amount of in-store purchases and/or information indicating that the user has blocked in-store purchases using the digital credential and/or information indicating that no financial account is associated with the user's account on account data server 116.

After receiving the financial account information, store server 104 can send a payment transaction request to payment processing server 118 (message 1322). This request can include any data that may be of use in processing the payment transaction, including an identifier of store 102 as a merchant, the customer's financial account information, the purchase amount, and/or other transaction details such as identification of particular products purchased or general product categories or the like. Payment processing server 118 can process the request and respond with a success or failure notification (message 1324).

In some embodiments, if financial account information (message 1320) is not received by store server 104, store server 104 does not send the payment transaction request (message 1322) to server 118; instead, server 104 can simply proceed to notify the customer and the employee of the error by sending error messages to customer device 106 (message 1328) and to employee device 108 (message 1326).

When the payment transaction is completed (successfully or not, as the case may be), store server 104 can send a success or error message to customer device 106 (message 1328) and to employee device 108 (message 1326). These messages can be presented to the customer and employee by their respective devices, and the messages as presented can be the same or different. (An example is described below.) If the transaction failed, customer device 106 and/or employee device 108 can prompt the customer and/or the employee to retry or to contact a supervisor. In some instances, in the event of error or failure, messages 1326 and 1328 can indicate the nature of the error (e.g., whether the digital credential was not recognized or whether the transaction was denied by the processor or whether the user account does not permit the transaction), and the customer and/or employee can be prompted appropriately depending on the nature of the error.

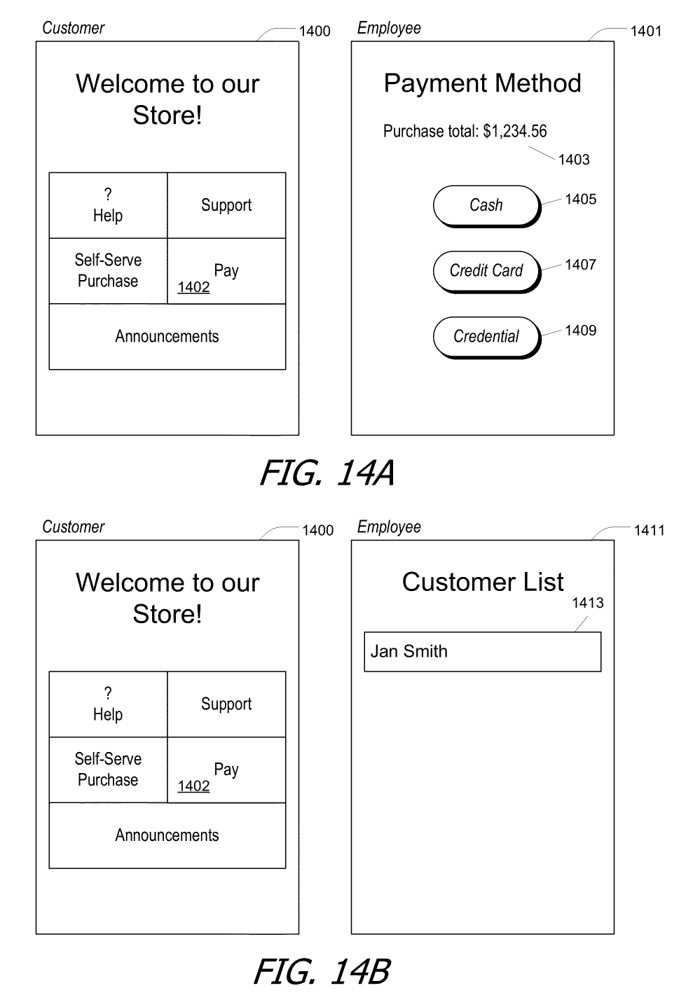

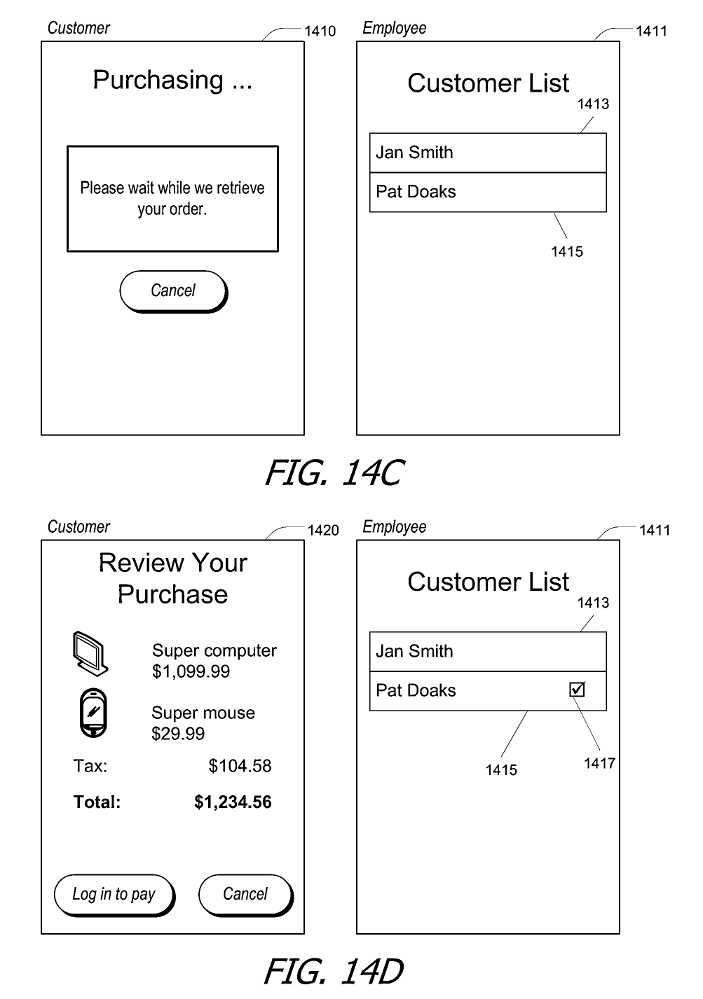

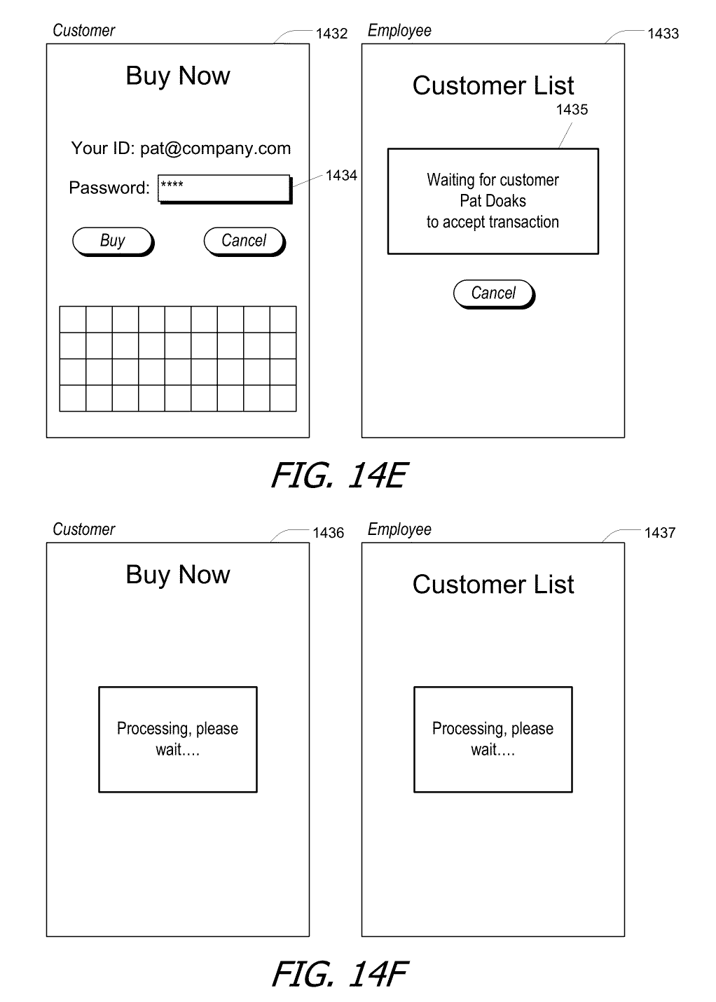

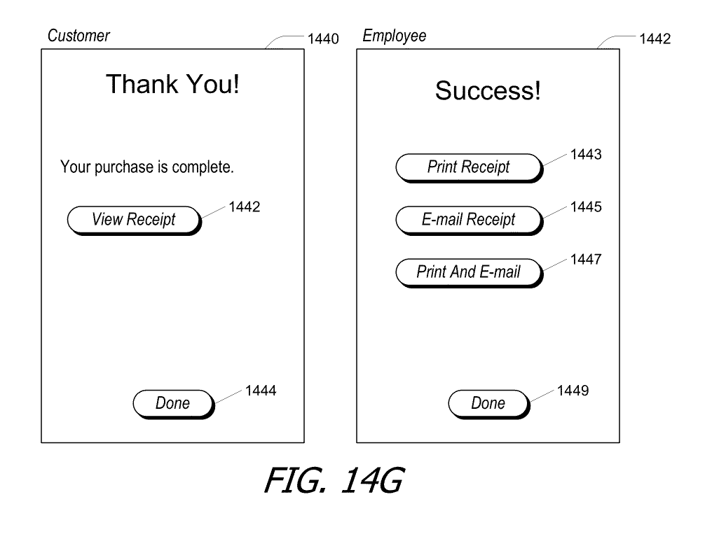

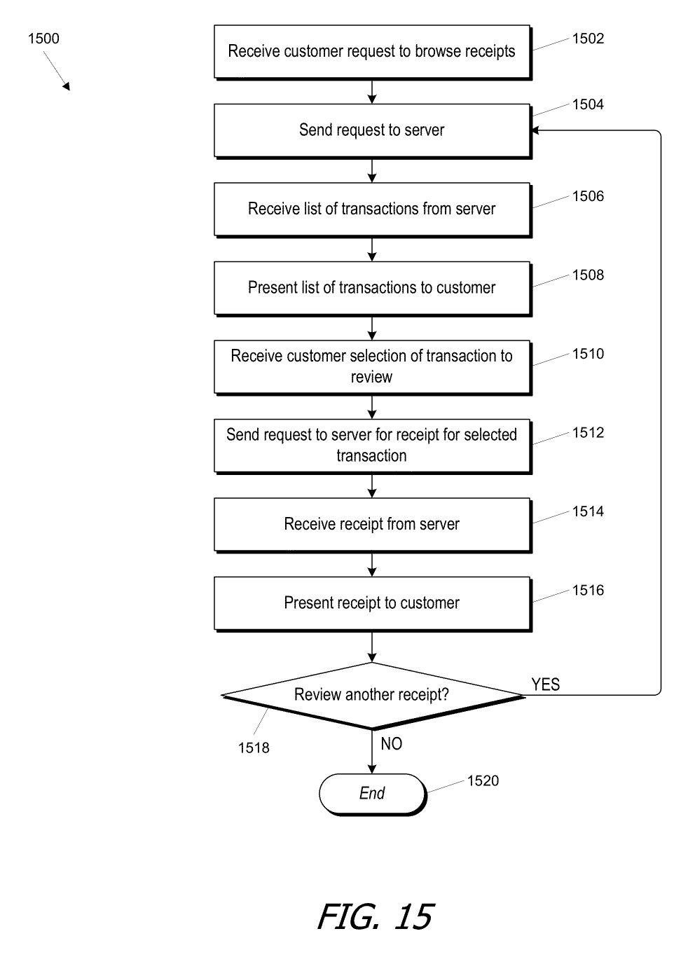

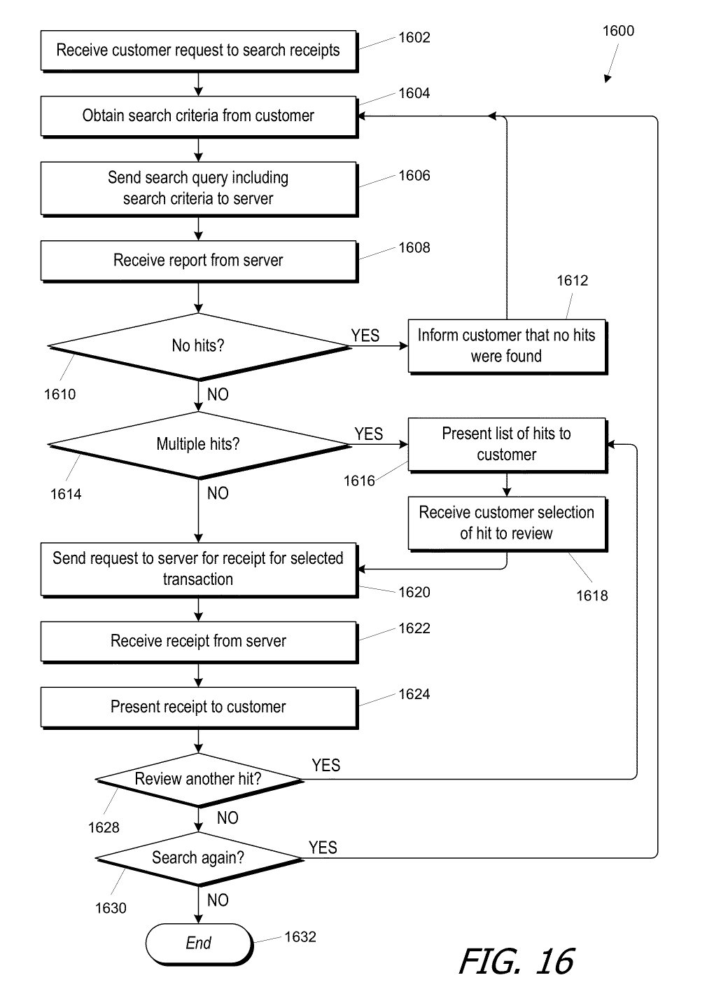

A further understanding of the customer and employee experience of an employee-assisted transaction can be had by reference to FIGS. 14A-14G, a sequence of corresponding screen images for customer device 106 (on the left) and employee device 108 (on the right) at different stages in an employee-assisted transaction according to an embodiment of the present invention. In these examples, it is assumed that customer device 106 and employee device 108 each provide a touch-screen display, and the customer or employee can touch areas of the screen in order to activate various functions.

FIG. 14A illustrates an initial screen 1400 for customer device 106 and an initial screen 1401 for employee device 108. Screen 1400 can be an initial screen for a retail app executing on customer device 106 and as such can be generally similar to screen 900 of FIG. 9A described above. In this example, screen 1400 includes a “Pay” button that can be used to initiate payment for an employee-assisted transaction using a digital credential (e.g., using process 1000 described above).

Initial employee screen 1401 can be displayed, e.g., after the employee has scanned the product(s) to be purchased and indicated that scanning of products is complete. Screen 1401 displays a purchase total 1403, which the employee can read or show to the customer, and payment-media selection buttons, such as button 1405 for indicating a cash transaction, button 1407 for indicating a credit card transaction, and button 1409 for indicating that payment will be made using the customer's digital credential. The employee can ask the customer how she wishes to pay and can select one of buttons 1405, 1407, 1409 based on the customer's response. (It is to be understood that any combination of payment media can be supported, not limited to the examples shown herein.)

Assuming that the customer replies that she will use her digital credential, the employee can select button 1409. This can cause employee device 108 to begin polling store server 104 to obtain the current payment queue. FIG. 14B illustrates that employee device 108 can begin to display screen 1411, which lists customers 1413 from whom store server 104 has received requests to be added to the payment queue and who are not yet associated with any transaction. At this point (or an earlier point), the customer can select “Pay” button 1402 from screen 1400 on her device to request to be added to the queue.

FIG. 14C illustrates that after the customer selects “Pay” button 1402, customer device 106 can display a purchasing screen 1410 indicating that her order is being retrieved. In the meantime, server 104 has added the customer's name (in this example, “Pat Doaks”) to the payment queue, and that name can now appear (at 1415) on screen 1411 of employee device 108. The employee can then select box 1415, thereby instructing employee device 108 to send a transaction creation message including the selected name to server 104. Server 104 can then generate the transaction detail message to be sent to customer device 106.

FIG. 14D illustrates that customer device 106 can display screen 1420 to present transaction details to the customer. The transaction details can include product information 1422, tax details 1424, and total purchase amount 1426. The customer can select button 1428 to pay or button 1430 to cancel the transaction. In the meantime, employee device 108 can continue to display customer list screen 1411; the selected name 1415 can be highlighted or marked (e.g., checkmark 1417) to indicate that a transaction involving this customer is in progress.

FIG. 14E illustrates that after the customer selects payment button 1428, customer device 106 can display screen 1432, which in this example prompts the customer to enter a password at 1434. (Screen 1432 can be similar or identical to screen 930 of FIG. 9D.) After the customer enters the credential, customer device 106 can send the credential in a payment instruction message to server 104. While the customer is entering a credential, employee device 108 can display status screen 1433, with a message box 1435 indicating that server 104 is waiting for a response from the customer. (The employee may guide the customer through the login process while this screen is displaying or simply wait for the customer to complete the process.)

FIG. 14F illustrates that after server 104 receives the payment instruction message, customer device 106 can display a processing screen 1436 while employee device 108 can display a similar processing screen 1437. For example, when server 104 receives the payment instruction message from customer device 106, server 104 can send an immediate acknowledgement to customer device 106 and to employee device 108, receipt of this acknowledgement can trigger the devices to display screens 1436 and 1437 while server 104 process the payment instruction. Once processing is complete, server 104 can send a success (or error) message to customer device 106 and employee device 108.

FIG. 14G illustrates that after receiving a success message, customer device 106 can display a completion screen 1440 while employee device 108 can display a completion screen 1441. From screen 1440, a customer can select button 1442 to view the purchase receipt or button 1444 to return to initial screen 1400. From completion screen 1441, the employee can select button 1443 to print a receipt for the customer, button 1445 to e-mail the receipt to the customer (e.g., using an e-mail address associated with the user's digital credential or an e-mail address entered by the employee on a subsequent screen, not shown), or button 1447 to both print and e-mail the receipt. “Done” button 1449 can return employee device 108 to an initial screen of the retail app (not shown in FIGS. 14A-14G, from which the employee can select various options, including scanning a product for another purchase transaction.

It will be appreciated that the foregoing employee-assisted transaction processes and devices are illustrative and that variations and modifications are possible. Process steps described as sequential may be executed in parallel, order of steps may be varied, and steps may be modified, combined, added or omitted. Any number of products can be purchased separately or together in a single transaction, and a particular customer device may support employee-assisted transactions in addition to or instead of self-service transactions.

In some embodiments, employees and customers both use mobile devices for purchase transactions. However, in an employee-assisted transaction, a customer can also use a mobile device to pay in instances where the employee operates a device (e.g., a cash register or point-of-sale system) that is installed in a fixed location and is capable of performing employee-device operations described herein (e.g., reading product identifiers and retrieving information, identifying a customer whose device is to be used in the purchase transaction, etc.). Thus, the employee device need not be mobile. The customer can carry her own mobile device into the store and bring it and her products to the fixed location of the employee device in order to complete a transaction.

In some embodiments, the customer can provide her digital credential without using her mobile device. For example, employee device 108 can be configured to allow the credential to be entered into employee device 108. By way of illustration, referring to FIG. 14A, when the employee selects “credential” button 1409, a new prompt can appear to allow the employee to indicate whether the credential will be provided using employee device 108 or customer device 106. The employee can ask the customer for her preference and choose accordingly. If the employee selects that the credential will be provided using employee device 108, a login screen can be displayed on employee device 108, and the employee can hand device 108 to the customer to enter her own credential.

As another example, another device in the store can be used to enter the credential. For example, various in-store electronic devices can be placed near where products for sale are displayed and/or near cash registers or other payment locations within the store. These in-store devices can be used to provide product information, summon employee assistance, or the like. In some embodiments, the employee (or the customer) can interact with the in-store device to initiate a payment on the customer's behalf, and the in-store device can prompt the customer to enter her credential. In some embodiments, the employee can use employee device 108 to associate the transaction with the in-store device, and the transaction can proceed similarly to the examples described above, with the in-store device performing various operations in place of the customer device.

Some embodiments provide additional capabilities for customer device 106 and/or employee device 108. For example, in some embodiments, a customer can review receipts for previous purchases made using her digital credential in a convenient interface, e.g., an interface provided by retail app 216. In some embodiments, the ability to review receipts is available regardless of whether customer device 106 is currently in a store.

In some embodiments, the receipts can be dynamically generated in response to a request from the customer for purchase transaction data stored by store server 104. (This transaction data can be stored locally to store server 104 and/or remotely, e.g., at account data server 116.) This can allow a customer to browse or search her receipts.

When browsing receipts, the customer can start with a list of all receipts and select a particular receipt to view. FIG. 15 is a flow diagram of a process 1500 for browsing receipts according to an embodiment of the present invention. Process 1500 can be implemented on a mobile device (e.g., customer device 106) or any other computer system that has access to a store's purchase records (e.g., to store server 104). At block 1502, customer device 106 can receive a customer request to browse receipts for past purchases. For example, customer device 106 can be executing retail app 216, which can include a control operable to indicate the customer's desire to browse receipts. In some embodiments, this control can be operable regardless of whether customer device 106 is currently in the store.

At block 1504, customer device 106 can send a request for a transaction list to a server. The server can be store server 104 or any other server where transaction records for purchases made in store 102 are stored. The request can include an identifier of the customer (e.g., an e-mail address). In some embodiments, the request can also include a digital credential verifying the customer's identity; this can be, e.g., the same digital credential used to make purchases in embodiments described above.

The server can use the request to identify transactions associated with the customer. Transactions can be associated with a customer in various ways. For example, a transaction can be associated with the customer's e-mail address, the digital credential, or the customer device. In some embodiments, the server can search a transaction history database using various search criteria (customer e-mail address, a customer ID associated with the digital credential, customer device identifier, etc.) to locate transaction records associated with the customer. The server can construct a list of all such records or a subset of such records (e.g., transactions within the last 3 months, last 6 months, or last year). If the server manages data for multiple stores, purchase records for all stores can be searched.

At block 1506, customer device 106 can receive the transaction list from the server. The transaction list can include partial information about each transaction in the list. For example, the list entry for a transaction can include the date, location of the store (which may be useful, e.g., if the customer has visited multiple stores), total price paid, and/or brief identifier(s) of some or all of the items purchased.

At block 1508, customer device 106 can present the transaction list to the customer. At block 1510, customer device 106 can receive the customer's selection of a transaction from the list to review. At block 1512, customer device 106 can send to the server a request for a receipt for the selected transaction.

At block 1514, customer device 106 can receive the receipt from the server, and at block 1516, customer device 106 can present the receipt to the customer, e.g., by displaying it. The receipt can include information about the store where the purchase was made (e.g., store name and address), date and time of purchase, total price paid, and complete or partial identification of the financial account charged (e.g., last four digits of a credit card or other account number). The receipt can also include details about the items purchased, price of each item, indication of any discounts (e.g., if the item was on sale, both regular and sale prices can be shown), and taxes or other fees paid. In some embodiments, the information can be arranged in a manner similar to a conventional printed purchase receipt, making it easy for a customer to review. It should be noted that the server can but need not store receipts in a human-readable format; the server can generate a receipt dynamically from the stored transaction data in response to a request.

At block 1518, customer device 106 can determine whether the customer would like to review another receipt, e.g., based on customer input. If so, then process 1500 can return to block 1504 to request the transaction list. (In another embodiment, process 1500 can return to block 1508 to present the most recently received transaction list again.) If the customer is finished reviewing receipts, process 1500 can end (block 1520).

Browsing receipts is not always the most convenient way of finding a particular transaction; sometimes, customers may appreciate the ability to search for a desired transaction using criteria they specify. FIG. 16 is a flow diagram of a process 1600 for searching for a receipt according to an embodiment of the present invention. Process 1600 can be implemented on a mobile device (e.g., customer device 106) or any other computer system that has access to a store's purchase records (e.g., to store server 104).

At block 1602, customer device 106 can receive a customer request to search receipts for past purchases. For example, customer device 106 can be executing retail app 216, which can include a control operable to indicate the customer's desire to search receipts. In some embodiments, this control can be operable regardless of whether customer device 106 is currently in the store.

At block 1604, customer device 106 can obtain search criteria from the customer. For example, customer device 106 can present a search interface screen (or sequence of voice prompts) that prompts the customer to enter various search criteria. Any combination of criteria can be used. For example, the customer can provide a date or date range, a total price or total price range, a particular store location, and/or a particular item purchased. (Any ranges can be open-ended, e.g., “after Jun. 30, 2011,” or bounded at both ends, e.g., “between Apr. 1, 2011 and Jun. 30, 2011,” as desired.)

At block 1606, customer device 106 can send a search query to the server. The search query can include the search criteria specified by the customer, in addition to an identifier of the customer (e.g., an e-mail address or other identifier described above). In some embodiments, the request can also include a digital credential verifying the customer's identity; this can be, e.g., the same digital credential used to make purchases in embodiments described above.

The server can use the query to search transactions associated with the customer. (The association of transactions with a customer can be determined in the same manner as described above with reference to browsing receipts, and the search can be performed on the same transaction history database.) Each transaction that matches the search criteria can be identified as a “hit.” At block 1608, customer device 106 can receive a search report from the server. The search report can include an indication of the number of hits and/or a list of hits. This list, like the transaction list in process 1500, can include partial information about the transaction.

At block 1610, if no hits were found, customer device 106 can inform the customer of this result at block 1612. In some embodiments, the customer can be prompted to search again, in which case, process 1600 can return to block 1604. In some embodiments, on returning to block 1604, the search interface can be prepopulated with criteria from the last search, which the customer can modify or clear.

If, at block 1610, at least one hit was found, then at block 1614, customer device 106 can determine whether multiple hits were found. If so, then at block 1616, customer device 106 can present a list of hits to the customer, and at block 1618, customer device 106 can receive the customer's selection of a transaction from the list of hits to review.

At block 1620, customer device 106 can send a request to the server for a receipt for the selected transaction, which can be either the single hit that was found (if block 1614 determines that only one hit was found) or the transaction selected from the list of hits at block 1618. At block 1622, customer device 106 can receive the requested receipt from the server, and at block 1624, customer device 106 can present the receipt to the customer. These blocks can be similar or identical to corresponding blocks of process 1500 described above; as in that example, the formatted receipt can be generated by the server dynamically from the transaction data.

At block 1628, customer device 106 can determine whether the customer wants to review another hit (assuming there were multiple hits). If so, process 1600 can return to block 1616 to present the hit list from the last search. If the customer is finished reviewing hits for the current search, then at block 1630, customer device 106 can determine whether the customer wants to search again. If so, process 1600 can return to block 1604 to receive new search criteria. In some embodiments, on returning to block 1604, the search interface can be prepopulated with criteria from the last search, which the customer can modify or clear. If, at block 1630, the customer is finished searching, process 1600 can end (block 1632).

It will be appreciated that these receipt browsing and searching processes are illustrative and that variations and modifications are possible. Steps described as sequential may be executed in parallel, order of steps may be varied, and steps may be modified, combined, added or omitted. For instance, in some embodiments, the same user interface can support both search and browsing; browsing can be implemented, e.g., by allowing a user to submit a search with no criteria specified, which can return a list of all transactions for which records are stored by the server. In some embodiments, the server can provide the transaction details in response to a request for a receipt, and the details can be formatted into a receipt by the customer device.

Transaction records for completed purchases can be maintained on the server for any period of time desired. In some embodiments, the length of time a particular record is maintained can be determined based on the transaction details. For example, if a purchased product is covered by a warranty (including an extended warranty purchased by the customer), it may be desirable to preserve the transaction record until after the warranty has expired. In some instances, legal requirements may determine a minimum length of time for which records should be maintained.

Processes 1500 and 1600 are not limited to being performed by a customer device. For example, server 104 (FIG. 1) or another server may provide an Internet-based interface (e.g., a web page) that can allow customers to review receipts from any device with access to the Internet. The customer may be required to log in using her digital credential (or perform other actions to verify her identity) in order to access receipt information via the Internet interface.

Using systems and methods as described herein can simplify and speed up sales transactions in a retail environment. In the case of self-service transactions, an employee need not participate. The customer can perform the entire transaction using her own mobile device, rather than a possibly unfamiliar self-service checkout kiosk installed in the store. This allows customers who know what they want to buy and do not have questions to make purchases quickly and efficiently, without having to wait for an employee to become available, and also allows employees to focus more attention on customers who can benefit from employee assistance. The store and/or can also apply customized limits on the availability of self-service transactions; such limits may reduce risk of theft or fraud and may also improve customer service.

In the case of both self-service and employee-assisted transactions, a digital credential can be used to facilitate payment as described above, with the customer using her own device to provide the credential. Providing the digital credential from a customer's device allows the customer to keep the credential (and associated financial account information) more secure, as she does not have to worry about providing either the credential or her financial account information to potentially unscrupulous employees. In addition, the customer need not carry a purchase card or cash or any other payment media; she can just carry her mobile device. The customer device also does not need to store sensitive financial account data that could be compromised if the device is lost, stolen, or hacked.

Further, in some embodiments, employees assisting with purchases do not need purchase card readers or the like; the store can accept payment using a digital credential supplied from a customer's mobile device, and the employee device need not have any special equipment for payment processing.

While the invention has been described with respect to specific embodiments, one skilled in the art with access to the present disclosure will recognize that numerous modifications are possible. A variety of devices, including mobile devices, can be used to allow a customer to make a purchase in a store using a mobile device, without having to provide financial account information to a store employee or in some instances without interacting with an employee at all. Products purchased can include goods and/or services. In some instances where services are purchased, the customer can be presented with a menu of available services and select from the menu, or the transaction can be employee-assisted, with the employee selecting or otherwise identifying the services.

The user account can be any account to which the store server has access when using the user's credential. For example, the user account can be associated with an online purchasing service (e.g., a service that facilitates purchasing of media content, executable software programs, or anything else deliverable via download from a server, while the store can sell electronic devices capable of presenting media content and/or executing software acquired from the online purchasing service. In other examples, the online purchasing service may facilitate ordering of goods to be delivered to a location selected by the user (e.g., home or office). In some embodiments, the online purchasing service can be operated by the owner or controlling entity of the store where the purchase is being made or by another entity as desired. (If the account data server and the store are not under common ownership or control, it is expected that an agreement would be in place between appropriate entities authorizing the store to access data stored on the account data server.) In other embodiments, the account data server need not be associated with any service other than supplying financial account information for use in in-store purchase transactions, and the same account data server can be accessed by a number of different stores that might or might not be under common ownership or control with each other or with the account data server.

In some embodiments, the particular store at which the purchase is made can be identified as the merchant for purposes of payment transaction processing. This facilitates accounting for sales on a per-store basis, regardless of whether customers elect to pay using digital credentials or other payment media. In other embodiments, the service associated with the account data server (i.e., the service that stores the user's financial account information) can be identified as the merchant, or an entity that owns or controls both the store and the service associated with the account data server can be identified as the merchant.

In some embodiments, the option to purchase from store inventory using a digital credential entered into a customer device is available only when the customer device is in the store. A customer device can determine whether it is in a store in various ways. For example, the customer device can determine its current location (e.g., using GPS to determine coordinates) and comparing the current location to a known location of the store. As another example, the customer device can determine whether it is in a store based on whether it has a LAN connection to a store server; in some embodiments, the customer device can also compare an identifier of the store server to an expected identifier associated with the store to confirm that it is connected to the desired server.

Portions of the description may refer to particular user interfaces, such as touchscreen displays. Other embodiments may use different interfaces. For example, a user interface can be voice-based, with the user speaking instructions into a microphone or other audio input device and the device providing an audible response (e.g., using synthesized speech or pre-recorded audio clips). A combination of voice-based and visual interface elements can be used, and in some embodiments, multiple different types of interfaces can be supported, with the user having the option to select a desired interface, to use multiple interfaces in combination (e.g., reading information from the screen and speaking instructions) and/or to switch between different interfaces. Any desired form of user interaction with a device can be supported.

Embodiments of the present invention can be realized using any combination of dedicated components and/or programmable processors and/or other programmable devices. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method for purchasing a product by a customer operating a customer mobile device, the method comprising:
obtaining, by the customer mobile device, a product identifier for a product offered for sale in a store;
transmitting, by the customer mobile device, the product identifier to a store server associated with the store;
receiving, by the customer mobile device, product information from the store server, the product information including a price of the product;
presenting to the customer, by the customer mobile device, at least some of the received product information, including the price of the product;
receiving, by the customer mobile device, customer purchasing input, the customer purchasing input including a digital credential for the customer, the digital credential being usable to access a user account record that stores financial account information for a financial account of the customer, the user account record being maintained at an account data server;
transmitting, by the customer mobile device, a purchase request to the store server, the purchase request including the digital credential, wherein the store server uses the digital credential to obtain the financial account information and uses the financial account information to charge the price of the product to the financial account of the customer;
receiving, by the customer mobile device, a purchase confirmation from the store server, the purchase confirmation indicating that the product has been purchased by the customer; and
presenting to the customer, by the customer mobile device, a confirmation message confirming that the purchase transaction for the product has successfully completed.

2. The method of claim 1 further comprising:
detecting, by the customer mobile device, that the customer mobile device has entered the store,
wherein transmitting the purchase request to the store server occurs only after detecting that the customer mobile device has entered the store.

3. The method of claim 2 wherein detecting that the customer has entered the store includes:
determining, by the customer mobile device, a current location of the customer mobile device; and
comparing, by the customer mobile device, the current location of the customer mobile device to a known location of the store.

4. The method of claim 2 wherein detecting that the customer has entered the store includes:
establishing a connection to the store server using a local area network; and
recognizing the store server as being associated with the store.

5. The method of claim 1 wherein the digital credential includes a user identifier and a password.

6. The method of claim 1 wherein obtaining the product identifier includes:
capturing an image of a product identification symbol using a camera of the customer mobile device; and
analyzing the image to determine the product identifier.

7. The method of claim 1 wherein obtaining the product identifier includes:
capturing an image of a product identification symbol using a camera of the customer mobile device;
analyzing the image, by the customer mobile device, to compute a candidate product identifier and a reliability parameter for the computation of the identifier;
determining, by the customer mobile device, whether the candidate product identifier is usable based at least in part on the reliability parameter; and
in the event that the candidate product identifier is not usable:
providing, by the customer mobile device, a visual prompt to the customer indicating how to adjust the camera so as to improve the image; and
repeating the acts of capturing the image, analyzing the image, and determining whether the candidate product identifier is usable, until a usable candidate product identifier is obtained.

8. A method for selling a product to a customer operating a customer mobile device at a store, the method comprising:
establishing, by a store server associated with the store, a wireless connection to the customer mobile device while the customer mobile device is present in the store;
receiving from the customer mobile device, by the store server, product identifying information for a product to be purchased by the customer;
determining, by the store server, a price of the product;
providing to the customer mobile device, by the store server, product-related information including the price of the product;
receiving from the customer mobile device, by the store server, a purchase request, the purchase request including a digital credential for the customer;
communicating, by the store server, with an account data server remote from the store to obtain financial account information for a financial account of the customer using the digital credential;
communicating, by the store server, with a payment processing server remote from the store to process a payment transaction using the obtained financial account information;
determining whether the payment transaction was successfully processed; and
transmitting, by the store server, a notification to the customer mobile device, the notification indicating whether the payment transaction was successfully processed.

9. The method of claim 8 wherein the account data server maintains a plurality of user account records for a plurality of users including the customer, each user account record including financial account information, and wherein the digital credential is used to access the one of the user account records that is maintained for the customer.

10. The method of claim 9 wherein each user account record includes a user preference parameter indicating whether in-store self-service transactions are permitted, the method further comprising:
determining, by the store server, whether the user account maintained for the customer permits in-store self-service transactions, the determination being based at least in part on the user preference parameter; and
in the event that the user account maintained for the customer does not permit in-store self-service transactions, sending, by the store server, a notification to the customer mobile device, the notification indicating that the purchase request failed.

11. A method for selling a product to a customer operating a customer mobile device at a store, the method comprising:
establishing, by a store server associated with the store, a wireless connection to the customer mobile device while the customer mobile device is present in the store;
receiving from the customer mobile device, by the store server, product identifying information for a product to be purchased by the customer;
determining, by the store server, a price of the product;
determining, by the store server, whether a self-service transaction is permitted for the product;
providing to the customer mobile device, by the store server, product-related information including the price of the product and an indication of whether the self-service transaction is permitted for the product; and
in the event that a self-service transaction is permitted for the product:
receiving from the customer mobile device, by the store server, a purchase request, the purchase request including a digital credential for the customer;
communicating, by the store server, with an account data server remote from the store to obtain financial account information for a financial account of the customer using the digital credential;
communicating, by the store server, with a payment processing server remote from the store to process a payment transaction using the obtained financial account information;
determining whether the payment transaction was successfully processed; and
transmitting, by the store server, a notification to the customer mobile device, the notification indicating whether the payment transaction was successfully processed.

12. The method of claim 11 wherein determining whether a self-service transaction is permitted for the product is based at least in part on the price of the product.

13. The method of claim 11 wherein determining whether a self-service transaction is permitted for the product is based at least in part on a location of the store.

14. The method of claim 11 wherein determining whether a self-service transaction is permitted for the product is based at least in part on a product type of the product.

15. A method for selling a product to a customer operating a customer mobile device in a store, the method comprising:
receiving, by a store server associated with the store, a payment request message from the customer mobile device, the payment request message including a first customer identifier and an indication that the customer will make a purchase using the customer mobile device;
receiving, by the store server, a transaction creation message from an employee device operated by an employee in the store, the transaction creation message including a second customer identifier identifying a person making a purchase from the employee;
associating, by the store server, the payment request message with the transaction creation message, wherein the association is based at least in part on matching the second customer identifier of the transaction creation message with the first customer identifier of the payment request message;
sending, by the store server, a transaction detail message to the customer mobile device, the transaction detail message including a price for the transaction and product identifying information for a product to be purchased by the customer;
receiving, by the store server, a payment instruction message from the customer mobile device, the payment instruction message including a digital credential associated with the customer;
processing, by the store server, the purchase transaction using the digital credential, wherein processing the purchase transaction includes charging the price of the one or more products to a financial account associated with the digital credential; and
in response to successful processing of the purchase transaction, sending, by the store server, a first confirmation message to the employee device and a second confirmation message to the customer mobile device, the first and second confirmation messages each indicating that the purchase transaction completed successfully.

16. The method of claim 15 wherein the employee device is a mobile device and the store server communicates wirelessly with the employee device.

17. The method of claim 15 wherein the transaction creation message further includes an identifier of the product to be purchased by the customer.

18. The method of claim 15 further comprising:
receiving, by the store server, one or more order messages from the employee device, each order message identifying a separate product to be included in a purchase transaction,
wherein the transaction creation message is associated with the one or more order messages.

19. The method of claim 15 further comprising:
in response to receiving the payment request message from the customer mobile device, adding, by the store server, the first customer identifier to a current queue of customers waiting to pay;
receiving from the employee device, by the store server, a request for the current queue;
in response to the request for the current queue, sending to the employee device, by the store server, the current queue, wherein the first customer identifier is selectable by the employee device from the current queue; and
after processing the purchase transaction, removing the first customer identifier from the current queue.

20. The method of claim 15 wherein processing the purchase transaction includes:
communicating, by the store server, with an account data server remote from the store to obtain financial account information for a financial account of the customer using the digital credential;
communicating, by the store server, with a payment processing server remote from the store to process a payment transaction using the obtained financial account information; and
determining whether the payment transaction was successfully processed.

21. A method for selling a product to a customer in a store using a mobile device operated by an employee in the store, the method comprising:
obtaining, by the employee mobile device, product information for the product to be sold to the customer;
providing, by the employee mobile device, the product information to a store server associated with the store;
receiving, by the employee mobile device, price information from the store server, the price information including a total price to be paid by the customer for the product;
sending to the store server, by the employee mobile device, an indication that the customer will pay for the product using a digital credential;
receiving from the store server, by the employee mobile device, a list of customers waiting to pay;
sending to the store server, by the employee mobile device, an identification of one of the customers on the list as the customer who will pay for the product, wherein in response to the identification, the store server performs a purchase transaction with a customer mobile device carried by the customer; and
receiving from the store server, by the employee mobile device, a confirmation that the purchase transaction completed successfully.

22. The method of claim 21 wherein the store server performs the purchase transaction with the customer mobile device without participation by the employee mobile device.
